(19) United States
(12) Patent Application Publication
(10) Pub. No.: US 2025/0185032 A1
(43) Pub. Date: Jun. 5, 2025

(54) TRANSMISSION OF SIDELINK BEAM REPORTING

(71) Applicant: APPLE INC., Cupertino, CA (US)

(72) Inventors: Chunxuan Ye, San Diego, CA (US); Oghenekome Oteri, San Diego, CA (US); Hong He, San Jose, CA (US); Wei Zeng, Saratoga, CA (US); Seyed Ali Akbar Fakoorian, San Diego, CA (US); Yushu Zhang, Beijing (CN); Dawei Zhang, Saratoga, CA (US); Weidong Yang, San Diego, CA (US); Zhibin Wu, Los Altos, CA (US); Chunhai Yao, Beijing (CN)

(21) Appl. No.: 18/842,935

(22) PCT Filed: Feb. 23, 2023
(86) PCT No.: PCT/US2023/063103

§ 371 Date: Aug. 30, 2024

Related U.S. Application Data
(60) Provisional application No. 63/268,861, filed on Mar. 4, 2022.

(51) Int. Cl. H04W 72/25; H04B 7/06; H04W 24/10

(52) U.S. Cl. CPC H04W 72/25; H04B 7/0626; H04W 24/10

(57) ABSTRACT

Systems and methods for sidelink (SL) beam maintenance procedures between a transmit (Tx) user equipment (UE) and a receive (Rx) UE are disclosed herein. The Tx UE may send a combined physical sidelink control channel (PSCCH)/physical sidelink shared channel (PSSCH) having one or more channel state information reference signals (CSI-RSs) on corresponding beams to the Rx UE. The Rx UE may perform beam measurement on the CSI-RSs and send a beam report to the Tx UE that is based on such measurement. Systems and methods for transmitting SL beam reporting via PSSCH, for transmitting SL beam reporting via PSFCH format 0, and for transmitting SL beam reporting via a large-format PSFCH are described herein.

### TECHNICAL FIELD

This application relates generally to wireless communication systems, including wireless communications systems that include a transmit (Tx) UE that communicates with a receive (Rx) UE using sidelink (SL) communications.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of SL channel state information reference signal acquisition between a transmit UE and a receive UE, according to an embodiment.

FIG. 2 illustrates an arrangement of SL resources, according to an embodiment.

FIG. 3 shows a diagram illustrating the use of frequency domain locations to identify beam indexes of multiple reported-on beams, according to an embodiment.

FIG. 4A illustrates a beam index/cyclic shift value correlation, according to an embodiment.

FIG. 4B illustrates a beam index/cyclic shift value correlation, according to an embodiment.

FIG. 5 illustrates a method of an Rx UE for performing SL communications with a Tx UE, according to an embodiment.

FIG. 6 illustrates a method of an Rx UE for performing SL communications with a Tx UE, according to an embodiment.

FIG. 7 illustrates a method of an Rx UE for performing SL communications with a Tx UE, according to an embodiment.

FIG. 8 illustrates a method of an Rx UE for performing SL communications with a Tx UE, according to an embodiment.

FIG. 9 illustrates a method of a UE for determining a priority between using PSFCH resources to send a first PSFCH transmission comprising a first beam report and using the PSFCH resources to receive a second PSFCH transmission comprising a second beam report, according to an embodiment.

FIG. 10 illustrates a method of a UE for determining a priority between using PSFCH resources to send a first PSFCH transmission comprising a first beam report and using the PSFCH resources to receive a second PSFCH transmission comprising a second beam report, according to an embodiment.

FIG. 11 illustrates a method of a UE for determining a priority between a first PSFCH communication for beam reporting and a second PSFCH communication for SL HARQ-ACK reporting, according to an embodiment.

FIG. 12 illustrates a method of a UE for determining a priority between a first PSFCH communication for beam reporting and a second PSFCH communication for SL HARQ-ACK reporting, according to an embodiment.

FIG. 13 illustrates a method of a UE for determining a priority between a first PSFCH communication for beam reporting and a second PSFCH communication for SL HARQ-ACK reporting, according to an embodiment.

FIG. 14 illustrates a method of a user UE for determining a priority between a first PSFCH communication for beam reporting and a second PSFCH communication for IUC, according to an embodiment.

FIG. 15 illustrates a method of a UE for determining a priority between a first PSFCH communication for beam reporting and a second PSFCH communication for IUC, according to an embodiment.

FIG. 16 illustrates a method for determining a priority between a first PSFCH communication for beam reporting and a second PSFCH communication for IUC, according to an embodiment

FIG. 17 illustrates a method for determining a priority between a first PSFCH communication for beam reporting and a second PSFCH communication for IUC, according to an embodiment.

FIG. 18 illustrates a method of a UE for determining a priority between a PSFCH communication for beam reporting in a first RAT and performing a scheduled SL communication in a second RAT, according to an embodiment.

FIG. 19 illustrates a method of a UE for determining a priority between a PSFCH communication for beam reporting and performing a scheduled uplink transmission, according to an embodiment.

FIG. 20 illustrates a method of a UE for determining a priority between a first PSFCH communication comprising a format 0 PSFCH and a second PSFCH communication comprising a large-payload format PSFCH that is longer than a format 0 PSFCH, according to an embodiment.

FIG. 21 illustrates a method of a UE for determining a priority between a first PSFCH communication comprising a format 0 PSFCH and a second PSFCH communication comprising a large-payload format PSFCH that is longer than a format 0 PSFCH, according to an embodiment.

FIG. 22 illustrates a method of a UE for determining a priority between a first PSFCH communication comprising a format 0 PSFCH and a second PSFCH communication comprising a large-payload format PSFCH that is longer than a format 0 PSFCH, according to an embodiment.

FIG. 23 illustrates a method of a UE for determining a priority between a first PSFCH communication comprising a format 0 PSFCH and a second PSFCH communication comprising a large-payload format PSFCH that is longer than a format 0 PSFCH, according to an embodiment.

FIG. 24 illustrates an example architecture of a wireless communication system, according to embodiments disclosed herein.

FIG. 25 illustrates a system for performing signaling between a first wireless device and a second wireless device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Embodiments of Sidelink (SL) CSI Acquisition

In embodiments herein, sidelink (SL) communications among two or more UE are discussed. The SL communications discussed herein contemplate communications that occur between the two or more UE without the use of an intermediary RAN device such as a base station. For example, the SL communications discussed herein include the case where signaling generated by a first UE is (directly) received at and used by a second UE.

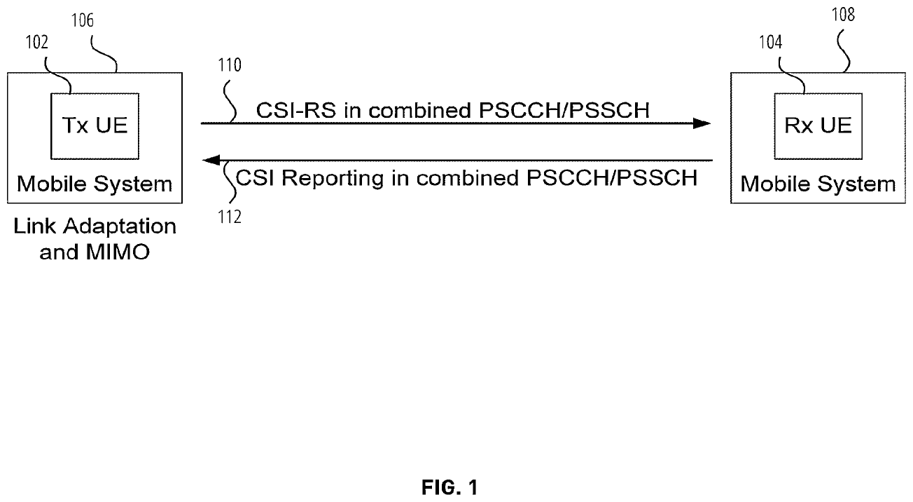

FIG. 1 illustrates a method of SL channel state information reference signal (CSI-RS) acquisition between a transmit (Tx) UE 102 and a receive (Rx) UE 104, according to an embodiment. As used herein, the term “Tx UE” may refer to a first UE that transmits a combined physical sidelink control channel (PSCCH)/physical sidelink shared channel (PSSCH) to an Rx UE. Accordingly, as used here, the term “Rx UE” may refer to a second UE that receives such a combined PSSCH/PSSCH.

In the embodiment of FIG. 1, the Tx UE 102 has been illustrated as part of the first mobile system 106 (e.g., a moving vehicle) and the Rx UE 104 has been illustrated as part of the second mobile system 108. This has been given by way of example and not by limitation. In other words, it is contemplated that one or both of the Tx UE 102 and the Rx UE 104 could be UE that are not in or on a mobile system.

As illustrated in FIG. 1, a first SL transmission 110 may be sent from the Tx UE 102 to the Rx UE 104. This transmission may include a CSI-RS in a combined PSCCH/PSSCH. The first SL transmission 110 may be a unicast transmission between the Tx UE 102 and the Rx UE 104. The first SL transmission 110 may have been previously configured as between the Tx UE 102 and the Rx UE 104 using SL communication (e.g., PC5-Radio Resource Control (PC5-RRC) signaling having the configuration as sent from the Tx UE 102 to the Rx UE 104). The use of the CSI-RS may be enabled or disabled by this such configuration information.

The Rx UE 104 is capable of measuring the CSI-RS once the first SL transmission 110 is received. The Rx UE 104 is further capable of sending a second SL transmission 112 that contains CSI reporting in a (second) combined PSCCH/PSSCH, whereby information regarding the CSI-RS (corresponding to the measurement of the CSI-RS by the Rx UE 104) is sent by the Rx UE 104 back to the Tx UE 102. The Tx UE 102 may trigger this CSI reporting using sidelink control information (SCI) included in the combined PSCCH/PSSCH that contains the CSI-RS.

In such embodiments, the location of the CSI-RS in the time domain may be understood by the Rx UE 104 to be the slot where the CSI trigger is received from the Tx UE 102. The location of the CSI-RS in the frequency domain may be understood to be within the physical resource blocks (PRBs) that are scheduled for use by the combined PSCCH/PSSCH in that same slot.

In some embodiments, the described triggering behavior for the SCI reporting may be aperiodic in nature. The contents of the CSI reporting may include one or more of a rank indicator (RI) and a channel quality index (CQI), which may then be used by the Tx UE 102 for link adaptation and/or multiple input multiple output (MIMO) precoding relative to subsequent SL transmission(s) from the Tx UE 102 to the Rx UE 104 (as is illustrated in FIG. 1). The CQI value may be generated based on, for example, a modulation and coding scheme (MCS) table known at the Rx UE 104. The RI and/or CQI values may be reported in a medium access control control element (MAC CE) carried with the combined PSCCH/PSSCH of the second SL transmission 112.

It may be that the Tx UE 102 does not issue multiple CSI triggers within a single CSI report window of the unicast session between the Tx UE 102 and the Rx UE 104. A latency bound for a CSI report (e.g., that controls the CSI report window length relative to the CSI trigger) may be signaled from the Tx UE 102 to the Rx UE 104 (e.g., via PC5-RRC signaling) such that the Rx UE 104 can ensure that transmissions of CSI reports by the Rx UE 104 to the Tx UE 102 occur within the CSI report window.

### Embodiments of Uu Beam Reporting

In some embodiments, beam reports may be transmitted from a UE to a base station on a Uu link. Such a beam report may include a measured quality value (e.g., a layer 1 (L1) reference signal received power (RSRP) (L1-RSRP) and/or an L1 signal to noise and interference ratio (SINR) (L1-SINR)) of one or more Tx beams used by the base station as measured at the UE. In such cases, a beam report may be transmitted from the UE to the base station in a physical uplink control channel (PUCCH) or a physical uplink shared channel (PUSCH). For example, if the beam report is an aperiodic beam report, it may be transmitted in a PUSCH, while semi-persistent and/or periodic beam reports may be sent in either of PUSCH or PUCCH.

In cases where a PUCCH with such L1-RSRP/L1-SINR data for beam reporting collides with a PUSCH that has data, the UE may multiplex the L1-RSRP/L1-SINR data with the data in the PUSCH in cases where a timeline requirement is met (e.g., in cases where the UE has enough time to transmit the L1-RSRP/LI-SINR data in the PUSCH). Otherwise, this collision may be considered an error case.

In cases where a PUCCH with such L1-RSRP/L1-SIRN data for beam reporting collides with another CSI report, a priority rule may be used to determine whether to drop the PUCCH or the other CSI report.

### Embodiments of SL Beam Reporting

Returning now to FIG. 1, embodiments disclosed herein discuss aspects of SL beam reporting between a Tx UE 102 and an Rx UE 104. Such embodiments may go beyond the reporting of RI/CQI as previously described in relation to FIG. 1, in that the first SL transmission 110 is configured to enable the Rx UE 104 to (also) report information that is particular to one or more of multiple Tx beams used by the Tx UE 102.

For example, in some embodiments, the Tx UE 102 may generate and send one or more CSI-RSs as part of the first SL transmission 110 (e.g., in a combined PSCCH/PSSCH). Each of these one or more CSI-RSs may be transmitted within the combined PSCCH/PSSCH on a corresponding one of one or more Tx beams of a beamforming used by the Tx UE 102 used to communicate with the Rx UE 104 (and note that such beams on which the one or more CSI-RSs are sent may be different than a Tx beam used by the Tx UE 102 to transmit the (rest of the) combined PSCCH/PSSCH itself). Once received at the Rx UE 104, the one or more CSI-RSs may be measured by the Rx UE 104. Examples of measurements that may be so taken include measuring an RSRP of the one or more CSI-RSs and/or measuring a SINR for the CSI-RSs, etc.

The first SL transmission 110 may include SCI that triggers beam measurement and beam reporting by the Rx UE 104 based on the CSI-RSs provided in the first SL transmission 110.

The second SL transmission 112 includes CSI reporting corresponding to the multiple CSI-RSs based on the measurements of the multiple CSI-RSs at the Rx UE 104. For example, measured L1-RSRP and/or L1-SINR values for one, some, or all of the multiple CSI-RSs may be included in this CSI reporting. Alternatively or additionally, an indication of one, some or all of a number X of the strongest CSI-RSs (e.g., CSI-RSs with the highest measured L1-RSRP and/or L1-SINR values) may be given.

Because of the correspondence between beams used to send the CSI-RSs and the CSI-RSs themselves, the Tx UE 102 is enabled (upon receiving the second SL transmission 112) to make conclusions regarding one or more of the beams. For example, if the second SL transmission 112 includes CSI reporting that indicates a given CSI-RS of the one or more CSI-RSs corresponds to a strongest/highest RSRP/SINR measured value, the Tx UE 102 can conclude accordingly that the beam used to send that given CSI-RS to the Rx UE 104 is a best beam to use for future transmissions to the Rx UE 104.

Herein, this CSI reporting that includes or indicates CSI-RS related information that can be related back to one or more individual beams by the Tx UE 102 in the manner described herein may be referred to as “beam reporting,” and an instance of such CSI reporting may accordingly be referred to herein as a “beam report.”

In some cases, the second SL transmission 112 having this CSI reporting may comprise a combined PSCCH/PSSCH. Further, as will be described herein, the second SL transmission 112 having this CSI reporting may comprise a physical sidelink feedback channel (PSFCH).

### Embodiments for Transmission of SL Beam Reporting Via PSSCH

In some embodiments, a combined PSCCH/PSSCH is used to transmit a beam report from the Rx UE 104 to the Tx UE 102.

In some of these embodiments, it may be that the beam report is carried in a MAC CE of the combined PSCCH/PSSCH. In some of these instances, a SL resource selection procedure (e.g., a mode 2 SL resource selection procedure) may be used at the Rx UE 104 to select the resources for the combined PSCCH/PSSCH. A priority value (prio_{Tx}) for the combined PSCCH/PSSCH used during the SL resource selection procedure may be received in SCI from the Tx UE 102 that triggered the beam reporting by the Rx UE 104. Alternatively, a priority value for the combined PSCCH/PSSCH used during the SL resource selection procedure may be determined relative to the MAC CE for the beam report (e.g., as has been configured and/or pre-defined at the Rx UE 104). In cases where the beam report is to be multiplexed with data of a PSSCH, then the lower priority value (corresponding to a higher priority level) associated with the PSSCH having the data or the combined PSCCH/PSSCH (determined in one of the manners just described) is used for the combined PSCCH/PSSCH as part of the SL resource selection procedure.

When using the SL resource selection procedure, a packet delay budget (PDB) for the combined PSCCH/PSSCH can be no greater than (e.g., is less than or equal to) a latency bound for the beam report. Further, during such SL resource selection procedures, the UE may use P_{rsvp_Tx}=0 (e.g., periodic transmission of the combined PSCCH/PSSCH is not performed).

In some instances where the beam report is carried in a MAC CE of the combined PSCCH/PSSCH, dedicated resources are used by the Rx UE 104 to transmit the combined PSCCH/PSSCH. In some cases, these dedicated resources may be resources that were reserved by SCI transmitted from the Tx UE 102 to the Rx UE 104. In such instances, it may be that retransmission resources are reserved by the Tx UE 102 for use by the Rx UE 104 for the combined PSCCH/PSSCH beam report.

In some cases, these dedicated resources may be determined at the Rx UE 104 according to a resource pool used for SL communications between the Tx UE 102 and the Rx UE 104. For example, certain sub-channels of a SL resource pool may be dedicated for use with the combined PSCCH/PSSCH having the beam report. The Rx UE 104 may be configured or pre-configured with a set of such reserved resources corresponding to the resource pool being used for the SL communications.

In some embodiments, it may be that the beam report is carried in stage 2 of SCI of the combined PSCCH/PSSCH. In some cases, stage 1 of the SCI may indicate a number of beam ID/measured quality value pairs that are to be indicated in stage 2 of the SCI.

In some cases, a maximum number of beams that can be reported using stage 2 of SCI may be configured and/or pre-configured to the Rx UE 104 according to the SL resource pool used for the SL communications between the Tx UE 102 and the Rx UE 104. Alternatively, a maximum number of beams that can be reported using stage 2 of SCI may be configured between the Tx UE 102 and the Rx UE 104 using SL signaling (e.g., PC5-RRC signaling) between the Tx UE 102 and the Rx UE 104.

The stage 2 of the SCI may have a payload size sufficient for the number of beams being reported.

### Embodiments for Transmission of SL Beam Reporting Via PSFCH Format 0

In some embodiments, one or more PSFCHs of format 0 may be used to transmit SL beam reporting from the Rx UE 104 to the Tx UE 102. In embodiments, a PSFCH format 0 may refer to a PSFCH that is arranged similarly or the same as a PUCCH format 0 in terms of sequence generation and resource mapping.

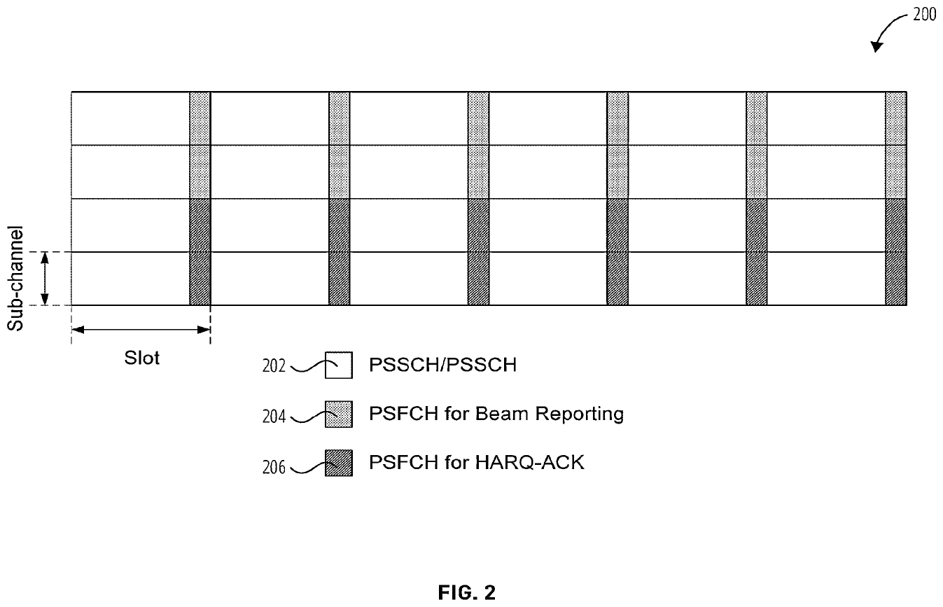

FIG. 2 illustrates an arrangement of SL resources 200, according to an embodiment. The SL resources 200 illustrates a combined PSCCH/PSSCH region 202, a PSFCH SL beam reporting region 204, and a PSFCH for hybrid automatic repeat request (HARQ) acknowledgement (ACK) (HARQ-ACK) region 206.

The combined PSCCH/PSSCH region 202 may be used for combined PSCCH/PSSCH transmissions as between the Tx UE 102 and the Rx UE 104. The PSFCH for HARQ-ACK region 206 may be used to transmit one or more PSFCHs containing HARQ signaling corresponding to one or more combined PSCCH/PSSCH transmissions of the combined PSCCH/PSSCH region 202.

The PSFCH SL beam reporting region 204 may be used to transmit one or more PSFCHs of format 0 having a beam report for one or more beam measurements taken using CSI-RS(s) of one or more combined PSCCH/PSSCHs (e.g., from the combined PSCCH/PSSCH region 202). An Rx UE 104 may identify one or more PSFCH resources from the PSFCH SL beam reporting region 204 that can be so used, and transmit one or more PSFCHs of format 0 that include/make up the beam report on the identified resources.

The PSFCH SL beam reporting region 204 may be located in the time domain according to a parameter for time domain PSFCH resource location for SL HARQ-ACK reporting. This is illustrated in FIG. 2 (where it can be seen that the PSFCH SL beam reporting region 204 has alignment in the time domain with the PSFCH for HARQ-ACK region 206). The parameter so used may be a sl-PSFCH-Period parameter that is also used for SL HARQ-ACK feedback configuration and/or inter UE coordination (IUC) configuration.

The location of the PSFCH SL beam reporting region 204 in the frequency domain may be configured separately from any configuration for a location of other PSFCH regions (e.g., the PSFCH for HARQ-ACK region 206). In some embodiments, the location of the PSFCH SL beam reporting region 204 in the frequency domain may be indicated by a bitmap indicating resource blocks (RBs) of the PSFCH SL beam reporting region. This bitmap may be delivered by an sl-PSFCH-RB-Set-RSRP parameter.

The location for the PSFCH SL beam reporting region 204 may be located in a code domain according to a parameter for applying cyclic shifting to SL HARQ-ACK reporting. The parameter so used may be a sl-NumMuxCS-Pair parameter for the number of cyclic shift pairs for such HARQ-ACKs.

The Rx UE 104 may be capable of determining a number of resources within the PSFCH SL beam reporting region 204 that are available for PSFCH format 0 beam reporting. Such resources may include one or more PRBs that each correspond to a PSFCH format 0 for a beam.

In a first case, the number of PSFCH resources that is available for PSFCH format 0 beam reporting is one.

In a second case, the number of PSFCH resources that is available for PSFCH format 0 beam reporting is determined at the Rx UE 104 according to a resource pool used for the combined PSCCH/PSSCH. In such cases, the Rx UE 104 may be configured or pre-configured with this value.

In a third case, the number of PSFCH resources that is available for PSFCH format 0 beam reporting is determined according to a parameter for determining a number of PSFCH resources for SL HARQ-ACK reporting. This parameter may be a sl-PSFCH-CandidateResourceType parameter.

In a fourth case, a number of PSFCH resources that is available for PSFCH format 0 beam reporting are reserved (with each resource associated with one beam). Then, the Rx UE 104 may report the measured quality value for each of the reported-on beams in a reserved resource that is associated with that particular reported-on beam.

In some embodiments using one or more PSFCHs of format 0 to transmit SL beam reporting, PSFCH resource mapping from PSSCH may use a similar mapping rule as a PSSCH to PSFCH mapping rule used for SL HARQ-ACK reporting on PSFCH.

Aspects of prioritization for PSFCH format 0 for beam reporting are now discussed. A priority of a format 0 PSFCH used for beam reporting may be the same as or as instructed by SCI information that triggered the beam reporting using the format 0 PSFCH.

In some cases, it may be that a UE is scheduled to use the same PSFCH resources to send a first format 0 PSFCH transmission (e.g., for beam reporting to a Tx UE for which the UE acts as an Rx UE) and to receive of a second format 0 PSFCH transmission (e.g., for beam reporting to an Rx UE for which the UE acts as a Tx UE). In such cases, the UE may determine whether to send the first format 0 PSFCH transmission or to receive the second format 0 PSFCH transmission.

It may be that a priority of the first format 0 PSFCH transmission (e.g., as received in SCI from the UE's Tx UE) and a priority of the second format 0 PSFCH transmission (e.g., corresponding to SCI that was sent to the UE's Rx UE by the UE) are compared, and the UE performs the one of the sending of the first format 0 PSFCH transmission and the receiving of the second format 0 PSFCH transmission that has the higher priority.

Alternatively, the UE may be configured to prioritize sending format 0 PSFCH transmissions over receiving format 0 PSFCH transmissions. Accordingly, in such cases, the UE performs the sending of the first format 0 PSFCH transmission.

In some cases, it may be that a UE is scheduled use the same PSFCH resources for a format 0 PSFCH communication for beam reporting (e.g., sending or receiving a format 0 PSFCH transmission for beam reporting) and for a format 0 PSFCH communication for SL HARQ-ACK reporting (e.g., sending or receiving a format 0 PSFCH transmission for SL HARQ-ACK reporting). In such cases, the UE may determine whether to perform the format 0 PSFCH communication for beam reporting or the format 0 PSFCH communication for SL HARQ-ACK reporting.

The UE may be configured to prioritize format 0 PSFCH communications for SL HARQ-ACK reporting over format 0 PSFCH communications for beam reporting. Accordingly, in such cases, the UE performs the format 0 PSFCH communication for SL HARQ-ACK reporting. The format 0 PSFCH communication for beam reporting may be discarded.

Alternatively, it may be that a priority of the format 0 PSFCH communication for beam reporting (e.g., as received/sent in SCI triggering the format 0 PSFCH communication for beam reporting) and a priority of the format 0 PSFCH communication for SL HARQ-ACK communication (e.g., as received/sent in SCI for a combined PSCCH/PSSCH that corresponds to the SL HARQ-ACK) are compared. The UE then performs the one of the format 0 PSFCH communication for beam reporting or the format 0 PSFCH communication for SL HARQ-ACK reporting that has the higher priority.

Alternatively, the UE may be configured to prioritize the transmission of format 0 PSFCH communications over the reception of format 0 PSFCH communications. Accordingly, the UE may determine that a first of the format 0 PSFCH communication for beam reporting and the format 0 PSFCH communication for SL HARQ-ACK corresponds to a format 0 PSFCH transmission, and that the other of the format 0 PSFCH communication for beam reporting and the format 0 PSFCH communication for SL HARQ-ACK corresponds to a format 0 PSFCH reception. The UE may then proceed to perform the one of the format 0 PSFCH communication for beam reporting and the format 0 PSFCH communication for SL HARQ-ACK that corresponds to the format 0 PSFCH transmission.

In some cases, it may be that a UE is scheduled to use the same PSFCH resources for a format 0 PSFCH communication for beam reporting (e.g., sending or receiving a format 0 PSFCH transmission for beam reporting) and for a format 0 PSFCH for IUC (e.g., sending or receiving IUC messages). In such cases, the UE may determine whether to perform the format 0 PSFCH communication for beam reporting or the format 0 PSFCH communication for IUC.

The UE may be configured to prioritize format 0 PSFCH communications for IUC over format 0 PSFCH communications for beam reporting. Accordingly, in such cases, the UE performs the format 0 PSFCH communication for IUC. The format 0 PSFCH communication for beam reporting may be discarded.

Alternatively, the UE may be configured to prioritize format 0 PSFCH communications for beam reporting over format 0 PSFCH communications for IUC. Accordingly, in such cases, the UE performs the format 0 PSFCH communication for beam reporting. The format 0 PSFCH communication for IUC may be discarded.

Alternatively, it may be that a priority of the format 0 PSFCH communication for beam reporting (e.g., as received/sent in SCI triggering the format 0 PSFCH communication for beam reporting) and a priority of the format 0 PSFCH communication for IUC (e.g., as received/sent in SCI for a combined PSCCH/PSSCH that corresponds to the IUC) are compared. The UE then performs the one of the format 0 PSFCH communication for beam reporting or the format 0 PSFCH communication for IUC that has the higher priority.

Alternatively, the UE may be configured to prioritize the transmission of format 0 PSFCH communications over the reception of format 0 PSFCH communications. Accordingly, the UE may determine that a first of the format 0 PSFCH communication for beam reporting and the format 0 PSFCH communication for IUC corresponds to a format 0 PSFCH transmission, and that the other of the format 0 PSFCH communication for beam reporting and the format 0 PSFCH communication for IUC corresponds to a format 0 PSFCH reception. The UE may then proceed to perform the one of the format 0 PSFCH communication for beam reporting and the format 0 PSFCH communication for IUC that corresponds to the format 0 PSFCH transmission.

In some cases, it may be that a UE is scheduled to use the same PSFCH resources for a format 0 PSFCH communication for beam reporting (e.g., sending or receiving a format 0 PSFCH transmission for beam reporting) in a first RAT and for SL communication in a second RAT (e.g., sending or receiving a SL transmission in the second RAT). In such cases, the UE may determine whether to perform the format 0 PSFCH communication for beam reporting in the first RAT or the SL communication in the second RAT.

It may be that a priority of the format 0 PSFCH communication for beam reporting in the first RAT (e.g., as received/sent in the first RAT in messaging (e.g., SCI) triggering the format 0 PSFCH communication for beam reporting) and a priority of the SL communication in the second RAT (e.g., as received/sent in the second RAT in messaging (e.g., SCI) corresponding to the SL communication in the second RAT) are compared. The UE then performs the one of the format 0 PSFCH communication for beam reporting in the first RAT or the SL communication in the second RAT that has the higher priority. In some examples, the first RAT may be NR, and the second RAT may be LTE.

In some cases, it may be that a UE is scheduled to use the same PSFCH resources for a format 0 PSFCH communication for beam reporting (e.g., sending or receiving a format 0 PSFCH transmission for beam reporting) and for and uplink transmission. In such cases, the UE may to determine whether to perform the format 0 PSFCH communication for beam reporting or the uplink transmission.

It may be that a priority of the format 0 PSFCH communication for beam reporting (e.g., as received/sent in messaging (e.g., SCI) triggering the format 0 PSFCH communication for beam reporting) and a priority of the uplink transmission (e.g., as received in downlink control information (DCI) scheduling the uplink transmission) are compared. The UE then performs the one of the format 0 PSFCH communication for beam reporting or the uplink transmission that has the higher priority.

Manners of encoding the beam reporting carried on PSFCH format 0 to a PSFCH resource are now discussed.

In a first alternative, it may be that a frequency domain location of a format 0 PSFCH indicates a measured quality of a beam being reported on. For example, if a format 0 PSFCH for a beam report for a beam is sent by the Rx UE 104 in a first location in the frequency domain, the Tx UE 102 may understand that the beam was measured with a first measured quality. Further, if the format 0 PSFCH for the beam report for that beam is instead sent by the Rx UE 104 in a second location in the frequency domain, the Tx UE 102 may understand that the beam was measured with a second (different) measured quality.

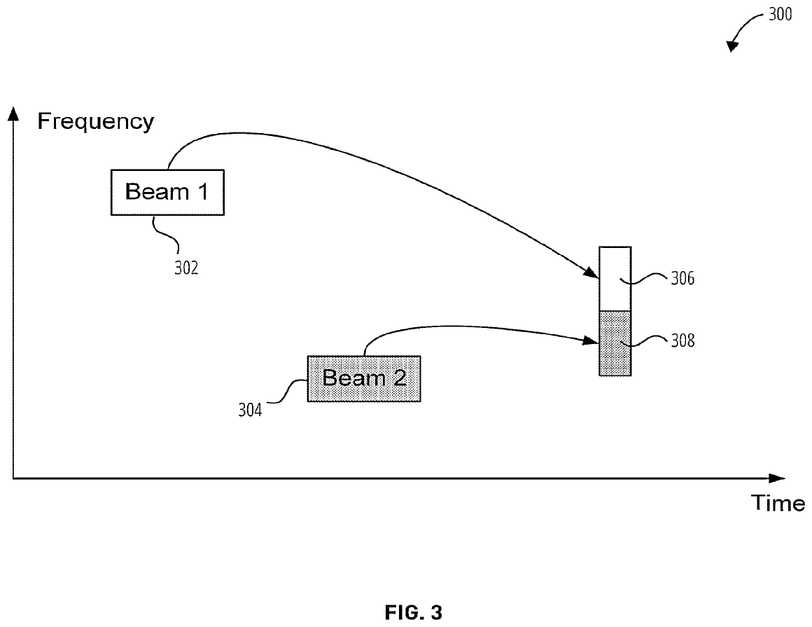

FIG. 3 shows a diagram 300 illustrating the use of frequency domain locations to identify beam indexes of multiple reported-on beams, according to an embodiment. FIG. 3 illustrates a first CSI-RS 302 (sent on a first beam, “Beam 1”) and a second CSI-RS 304 (sent on a second beam, “Beam 2). It may be that beam reports for Beam 1 correspond (e.g., via configuration) to the first format 0 PSFCH location 306, and that beam reports for Beam 2 correspond to the second format 0 PSFCH location 308.

Accordingly, an Rx UE 104 is enabled to indicate information regarding each of these beams by using (or not using) the first format 0 PSFCH location 306 and/or the second format 0 PSFCH location 308. For example, it may be that the first CSI-RS 302 has a measured quality that is the strongest out of all measured beams. It may be in such a case that the Rx UE 104 is configured indicated this to the Tx UE 102 by sending a format 0 PSFCH in the first format 0 PSFCH location 306. This may indicate to the Tx UE 102 that the beam associated with the first CSI-RS 302 (e.g., Beam 1) is the strongest out of all measured beams.

In another example, it may be that the first CSI-RS 302 and the second CSI-RS 304 each has a measured quality that is above (or at or above) a threshold. It may be in such a case that the Rx UE 104 is configured to indicate this to the Tx UE 102 my sending a format 0 PSFCH in in the first format 0 PSFCH location 306 (for Beam 1) and in the second format 0 PSFCH location 308 (for Beam 2). This may indicate to the Tx UE 102 that the first CSI-RSs on each of these beams were measured with a measured quality above (or at or above) the threshold.

In some embodiments, code domain locations may be used to identify beam indexes and/or measured quality values. For example, a cyclic shift value (mcs) applied to a format 0 PSFCH may indicate that the format 0 PSFCH corresponds to a CSI-RS sent on a particular beam index. Then, a frequency domain location of the format 0 PSFCH may indicate measured quality information corresponding to that beam index (e.g., as discussed herein).

Alternatively, a cyclic shift value applied to a format 0 PSFCH may indicate measured quality information for a CSI-RS corresponding to the format 0 PSFCH. Then, a frequency domain location of the format 0 PSFCH may indicate a beam index corresponding to the CSI-RS (e.g., as discussed herein).

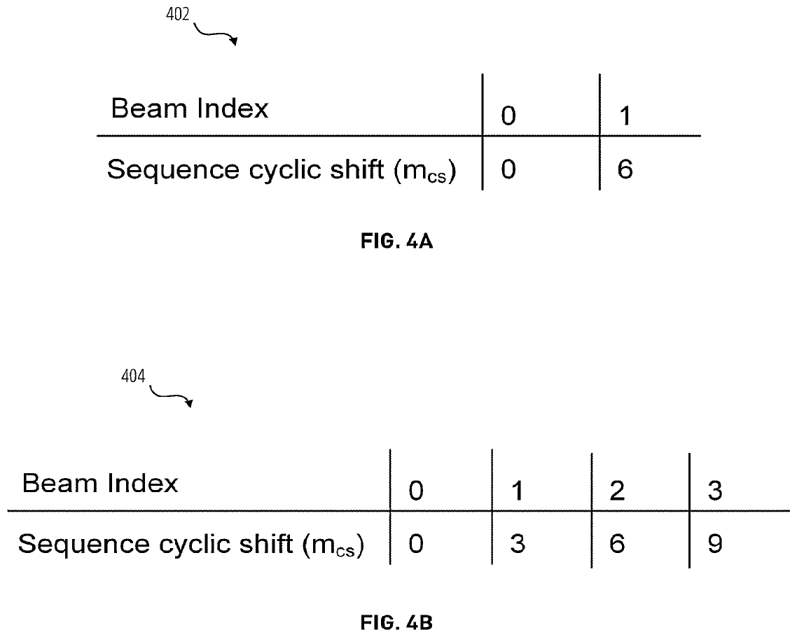

FIG. 4A illustrates a first beam index/cyclic shift value correlation 402, according to an embodiment. As can be seen, a cyclic shift value of 0 may correspond to a beam index 0, and a cyclic shift value of 6 may correspond to a beam index 1.

FIG. 4B illustrates a second beam index/cyclic shift value correlation 404, according to an embodiment. As can be seen, a cyclic shift value of 0 may correspond to a beam index 0, a cyclic shift value of 3 may correspond to a beam index 1, a cyclic shift value of 6 may correspond to a beam index 2, and a cyclic shift value of 9 may correspond to a beam index 3.

In some embodiments, a combination of frequency domain location and code domain location may be used to identify different measured quality values. For example, cyclic shift value/frequency domain location pairs may represent different measured quality values, and the format 0 PSFCH may indicate one of a plurality of measured quality values by using in the cyclic shift value/frequency domain location pair corresponding to its measured quality value.

### Embodiments for Transmission of SL Beam Reporting Via Large-Payload Format PSFCH

In some embodiments, one or more PSFCHs of a large-payload format may be used to transmit SL beam reporting from the Rx UE 104 to the Tx UE 102. In such circumstances, a Reed-Muller code or a downlink polar code may be used to encode the information bits. Further, it is contemplated that SL HARQ-ACK reporting may be jointly encoded with the SL beam reporting in a large-payload format PSFCH. In such cases, a SL HARQ-ACK bit may be added to the large-payload format PSFCH before the SL beam reporting bits.

A PSFCH SL beam reporting region usable with large-payload format PSFCHs for SL beam reporting may be located in the time domain according to a parameter for time domain PSFCH resource location for SL HARQ-ACK reporting/IUC. The parameter so used may be a sl-PSFCH-Period parameter that is also used for SL HARQ-ACK feedback configuration and/or IUC configuration.

The location of the PSFCH SL beam reporting region usable with large-payload format PSFCHs for SL beam reporting in the frequency domain may be configured separately from any configuration for a location of other PSFCH regions. In some embodiments, the location of the PSFCH SL beam reporting region usable with large-payload format PSFCHs for SL beam reporting in the frequency domain may be indicated by a bitmap indicating resource blocks (RBs) of such a PSFCH SL beam reporting region. This bitmap may be delivered by an sl-PSFCH-RB-Set-RSRP parameter.

The Rx UE 104 may be capable of determining a number of resources within the PSFCH SL beam reporting region usable with large-payload format PSFCHs for SL beam reporting that are available for large-payload format PSFCH beam reporting.

In a first case, the number of PSFCH resources that is available for large-payload format PSFCH beam reporting is determined at the Rx UE 104 according to a resource pool used for the combined PSCCH/PSSCH. In such cases, the Rx UE 104 may be configured or pre-configured with this value.

In a second case, the number of PSFCH resources that is available for large-payload format PSFCH beam reporting is determined according to a parameter for determining a number of PSFCH resources for SL HARQ-ACK reporting (e.g., in PRBs). This parameter may be a sl-PSFCH-CandidateResourceType parameter.

In some embodiments using one or more large-payload format PSFCHs to transmit SL beam reporting, PSFCH resource mapping from PSSCH may use a similar mapping rule as a PSSCH to PSFCH mapping rule used for SL HARQ-ACK reporting on PSFCH.

In other such cases, a time gap between PSSCH to the large-payload format PSFCH may be different (e.g., greater than) the PSSCH to PSFCH mapping rule used for SL HARQ-ACK reporting on PSFCH that uses a format 0 PSFCH. This may be to allow for additional processing time to prepare the large-payload format PSFCH as compared to the case of the format 0 PSFCH. This time gap may be configured or pre-configured to the Rx UE 104 based on the resource pool used for the SL communications between the Tx UE 102 and the Rx UE 104. Alternatively, this time gap may be otherwise configured or pre-defined at the Rx UE 104. In some embodiments, this time gap may be 3 slots after the PSSCH.

Aspects of prioritization for large-payload format PSFCHs for beam reporting are now discussed. A priority of a large-payload format PSFCH used for beam reporting may be the same as or as instructed by SCI that triggered the beam reporting using the format 0 PSFCH. Alternatively, the priority of a large-payload format PSFCH used for beam reporting may be set instead based on a configuration or pre-configuration for large-payload format PSFCHs according to the SL resource pool used for the SL communications between the Tx UE 102 and the Rx UE 104. Alternatively, the priority of a large-payload format PSFCH used for beam reporting may be set instead by SL signaling (e.g., PC5-RRC signaling) between the Tx UE 102 and the Rx UE 104.

In some cases, it may be that a UE is scheduled to use the same PSFCH resources for a large-payload format PSFCH communication for beam reporting (e.g., sending or receiving a large-payload format PSFCH transmission for beam reporting) in a first RAT and for SL communication in a second RAT (e.g., sending or receiving a SL transmission in the second RAT). In such cases, the UE may determine whether to perform the large-payload format PSFCH communication for beam reporting in the first RAT or the SL communication in the second RAT.

It may be that a priority of the large-payload format PSFCH communication for beam reporting in the first RAT (e.g., as received/sent in the first RAT in messaging (e.g., SCI) triggering the large-payload format PSFCH communication for beam reporting) and a priority of the SL communication in the second RAT (e.g., as received/sent in the second RAT in messaging (e.g., SCI) corresponding to the SL communication in the second RAT) are compared. The UE then performs the one of the large-payload format PSFCH communication for beam reporting in the first RAT or the SL communication in the second RAT that has the higher priority. In some examples, the first RAT may be NR, and the second RAT may be LTE.

In some cases, it may be that a UE is scheduled to use the same PSFCH resources for a large-payload format PSFCH communication for beam reporting (e.g., sending or receiving a large-payload format PSFCH transmission for beam reporting) and for an uplink transmission. In such cases, the UE may determine whether to perform the large-payload format PSFCH communication for beam reporting or the uplink transmission.

It may be that a priority of the large-payload format PSFCH communication for beam reporting (e.g., as received/sent in messaging (e.g., SCI) triggering the large-payload format PSFCH communication for beam reporting) and a priority of the uplink transmission (e.g., as received in downlink control information (DCI) scheduling the uplink transmission) are compared. The UE then performs the one of the large-payload format PSFCH communication for beam reporting or the uplink transmission that has the higher priority.

In some cases, it may be that a UE is scheduled to use the same PSFCH resources for a large-payload format PSFCH communication for beam reporting (e.g., sending or receiving a large-payload format PSFCH transmission for beam reporting) and for a format 0 PSFCH communication (e.g., sending or receiving a large-payload format PSFCH transmission). The format 0 PSFCH may include HARQ-ACK information or IUC data. In such cases, the UE may determine whether to perform the large-payload format PSFCH communication for beam reporting or the format 0 PSFCH communication.

It may be that the UE may be configured to prioritize performing format 0 PSFCH communications over performing large-payload format PSFCH transmissions. This may be because of a desire to prioritize the types of information of the format 0 PSFCH transmission (e.g., HARQ-ACK information, IUC data) over beam reporting information. Accordingly, in such cases, the UE performs the format 0 PSFCH communication.

Alternatively, may be that the UE may be configured to prioritize performing large-payload format PSFCH communications over performing format 0 PSFCH transmissions. This may be because of a desire to prioritize the PFSCH communications that are (typically) relatively larger, thereby increasing system efficiency. Accordingly, in such cases, the UE performs the large-payload format PSFCH communication.

Alternatively, the UE may be configured to prioritize the transmission PSFCH communications over the reception of PSFCH communications. Accordingly, the UE may determine that a first of the large-payload format PSFCH communication for beam reporting and the format 0 PSFCH communication corresponds to a PSFCH transmission, and that the other of the large-payload format PSFCH communication for beam reporting and the format 0 PSFCH communication corresponds to a PSFCH reception. The UE may then proceed to perform the one of the large-payload format PSFCH communication for beam reporting and the format 0 PSFCH communication that corresponds to the PSFCH transmission.

Alternatively, it may be that a priority of the large-payload format PSFCH communication for beam reporting (e.g., as received/sent in SCI triggering the format 0 PSFCH communication for beam reporting) and a priority of the format 0 PSFCH communication (e.g., as received/sent in SCI for a combined PSCCH/PSSCH that corresponds to the format 0 PSFCH) are compared. The UE then performs the one of the large-payload format PSFCH communication for beam reporting or the format 0 PSFCH communication that has the higher priority.

In some cases, it may be that a UE is scheduled to use the same PSFCH resources to send a first large-payload format PSFCH transmission for beam reporting (e.g., for beam reporting to a Tx UE for which the UE acts as an Rx UE) and to receive a second large-payload format PSFCH transmission for beam reporting (e.g., for beam reporting to an Rx UE for which the UE acts as a Tx UE). In such cases, the UE may determine whether to send the first large-payload format PSFCH transmission or to receive the second large-payload format PSFCH transmission.

It may be that a priority of the first large-payload format PSFCH transmission (e.g., as received in SCI from the UE's Tx UE) and a priority of the second large-payload format PSFCH transmission (e.g., corresponding to SCI that was sent to the UE's Rx UE by the UE) are compared, and the UE performs either of the sending of the first large-payload format PSFCH transmission or the receiving of the second large-payload format PSFCH transmission that has the higher priority.

### Example Embodiments

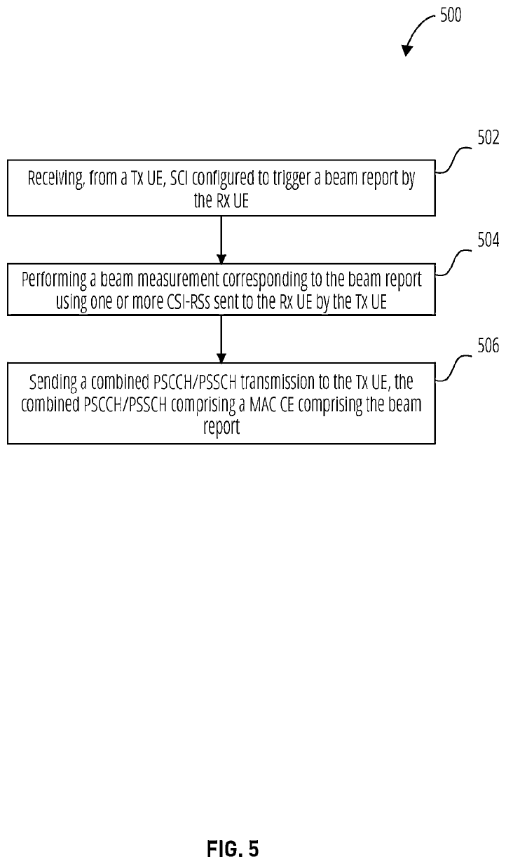

FIG. 5 illustrates a method 500 of an Rx UE for performing SL communications with a Tx UE, according to an embodiment. The method 500 includes receiving 502, from the Tx UE, sidelink control information (SCI) configured to trigger a beam report by the Rx UE.

The method 500 further includes performing 504 a beam measurement corresponding to the beam report using one or more CSI-RSs sent to the Rx UE by the Tx UE.

The method 500 further includes sending 506 a combined PSCCH/PSSCH transmission to the Tx UE, the combined PSCCH/PSSCH comprising a MAC CE comprising the beam report.

In some embodiments of the method 500, resources for the combined PSCCH/PSSCH transmission are selected according to a SL resource selection procedure. In some of these embodiments, a priority value for the combined PSCCH/PSSCH transmission used during the SL resource selection procedure is received in the SCI. In some of these embodiments, a priority value for the combined PSCCH/PSSCH transmission used during the SL resource selection procedure is determined at the Rx UE according to the MAC CE. In some of these embodiments, the MAC CE comprising the beam report is multiplexed with other data in the combined PSCCH/PSSCH, and a priority value for the combined PSCCH/PSSCH transmission used during the SL resource selection procedure is the lower of a first priority value corresponding to the beam report and a second priority value corresponding to the other data. In some of these embodiments, a packet delay budget (PDB) for the combined PSCCH/PSSCH transmission is less than or equal to a latency bound corresponding to the beam report.

In some embodiments of the method 500, the combined PSCCH/PSSCH transmission uses dedicated resources. In some of these embodiments, the dedicated resources are resources reserved by the SCI. In some of these embodiments, the dedicated resources are determined at the Rx UE according to a resource pool used for the combined PSCCH/PSSCH transmission.

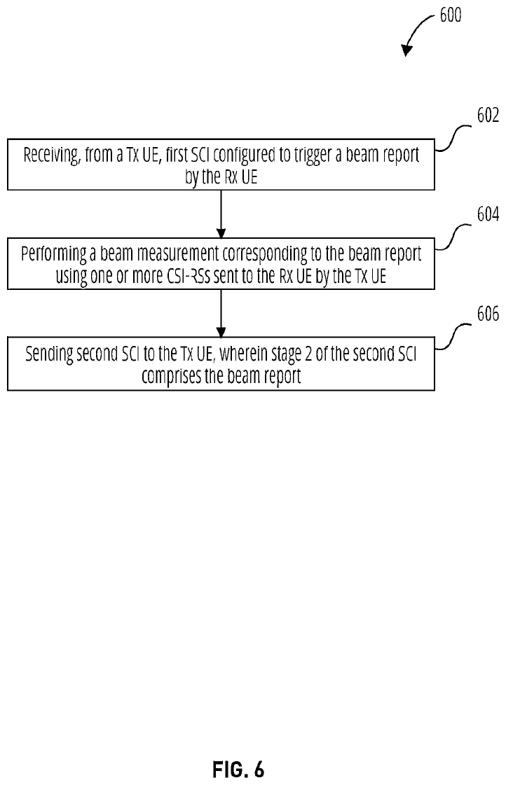

FIG. 6 illustrates a method 600 of an Rx UE for performing SL communications with a Tx UE, according to an embodiment. The method 600 includes receiving 602, from the Tx UE, first SCI configured to trigger a beam report by the Rx UE.

The method 600 further includes performing 604 a beam measurement corresponding to the beam report using one or more CSI-RSs sent to the Rx UE by the Tx UE.

The method 600 further includes sending 606 second SCI to the Tx UE, wherein stage 2 of the second SCI comprises the beam report.

In some embodiments of the method 600, stage 1 of the second SCI comprises a number of beam ID to measured quality value pairs used in the beam report.

In some embodiments of the method 600, the beam report comprises a measured quality of up to a number of beams that is known to the Rx UE. In some of these embodiments, the number of beams is pre-configured to the Rx UE according to a SL resource pool used for the second SCI. In some of these embodiments, the number of beams is configured to the Rx UE by SL signaling between the Rx UE and the Tx UE.

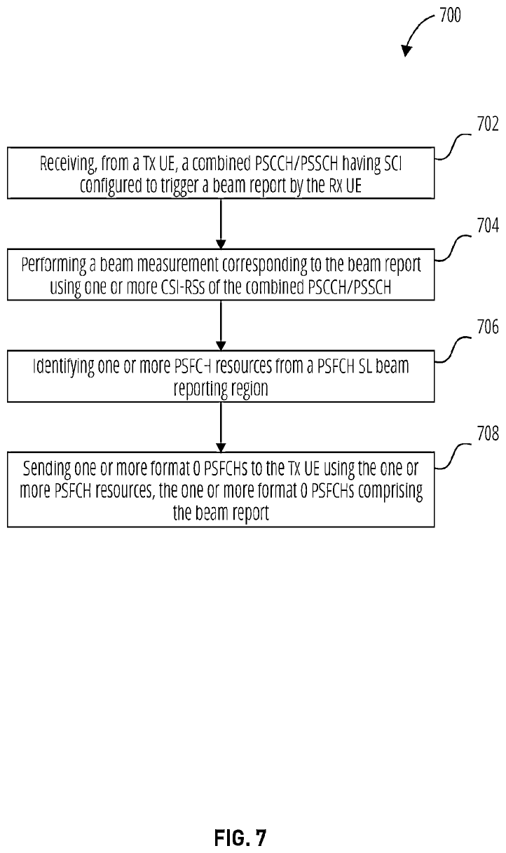

FIG. 7 illustrates a method 700 of an Rx UE for performing SL communications with a Tx UE, according to an embodiment. The method 700 includes receiving 702, from the Tx UE, a combined PSCCH/PSSCH having SCI configured to trigger a beam report by the Rx UE.

The method 700 further includes performing 704 a beam measurement corresponding to the beam report using one or more CSI-RSs of the combined PSCCH/PSSCH.

The method 700 further includes identifying 706 one or more PSFCH resources from a PSFCH SL beam reporting region.

The method 700 further includes sending 708 one or more format 0 PSFCHs to the Tx UE using the one or more PSFCH resources, the one or more format 0 PSFCHs comprising the beam report.

In some embodiments of the method 700, the PSFCH SL beam reporting region is located in a time domain according to a parameter for time domain PSFCH resource location for SL HARQ-ACK transmissions.

In some embodiments of the method 700, a location of the PSFCH SL beam reporting region in a frequency domain is indicated by a bitmap indicating RBs of the PSFCH SL beam reporting region.

In some embodiments of the method 700, the PSFCH SL beam reporting region is located in a code domain according to a parameter for applying cyclic shifting to SL HARQ-ACK reporting.

In some embodiments of the method 700, a number of the one or more PSFCH resources is determined at the Rx UE according to a resource pool used for the combined PSCCH/PSSCH.

In some embodiments of the method 700, a number of the one or more PSFCH resources is determined according to a parameter for determining a number of PSFCH resources for SL HARQ-ACK reporting.

In some embodiments of the method 700, the one or more PSFCH resources for SL beam reporting are reserved for corresponding format 0 PSFCHs that report on corresponding beams of the beam measurement.

In some embodiments of the method 700, frequency domain locations of the one or more format 0 PSFCHs indicate measured qualities for one or more beams of the beam report corresponding to the one or more format 0 PSFCHs.

In some embodiments of the method 700, frequency domain locations of the one or more format 0 PSFCHs identify beam indexes for one or more beams of the beam report corresponding to the one or more format 0 PSFCHs.

In some embodiments of the method 700, cyclic shifts applied to the one or more format 0 PSFCHs identify beam indexes for one or more beams of the beam report corresponding to the one or more format 0 PSFCHs.

In some embodiments of the method 700, cyclic shifts applied to the one or more format 0 PSFCHs indicate measured qualities for beams of the beam report corresponding to the one or more format 0 PSFCHs.

In some embodiments of the method 700, frequency domain locations of the one or more format 0 PSFCHs and cyclic shifts applied to the one or more format 0 PSFCHs indicate measured qualities for one or more beams of the beam report corresponding to the one or more format 0 PSFCHs.

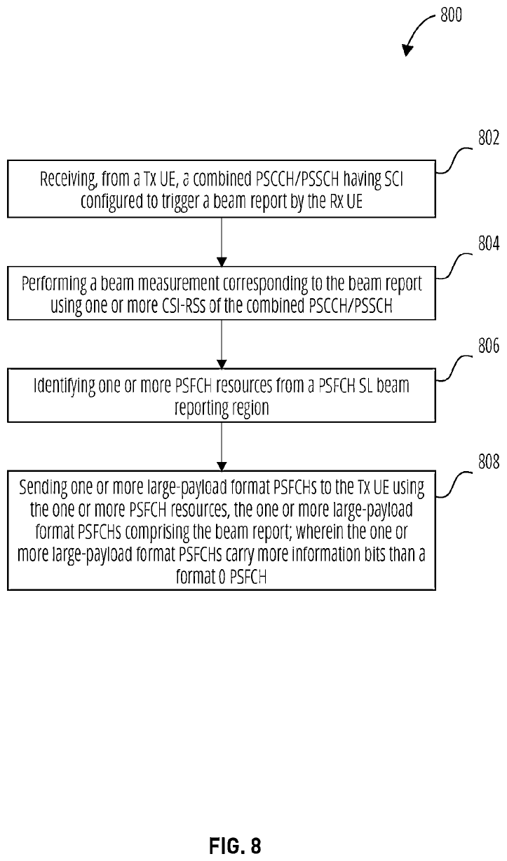

FIG. 8 illustrates a method 800 of an Rx UE for performing SL communications with a Tx UE, according to an embodiment. The method 800 includes receiving 802, from the Tx UE, a combined PSCCH/PSSCH having SCI configured to trigger a beam report by the Rx UE.

The method 800 further includes performing 804 a beam measurement corresponding to the beam report using one or more CSI-RSs of the combined PSCCH/PSSCH.

The method 800 further includes identifying 806 one or more PSFCH resources from a PSFCH SL beam reporting region.

The method 800 further includes sending 808 one or more large-payload format PSFCHs to the Tx UE using the one or more PSFCH resources, the one or more large-payload format PSFCHs comprising the beam report; wherein the one or more large-payload format PSFCHs carry more information bits than a format 0 PSFCH.

In some embodiments of the method 800, the PSFCH SL beam reporting region is located in a time domain according to a parameter for time domain PSFCH resource location for SL HARQ-ACK transmissions.

In some embodiments of the method 800, a location of the PSFCH SL beam reporting region in a frequency domain is indicated by a bitmap indicating RBs of the PSFCH SL beam reporting region.

In some embodiments of the method 800, a number of the one or more PSFCH resources is pre-configured according to a resource pool used for the combined PSCCH/PSSCH.

In some embodiments of the method 800, a number of the one or more PSFCH resources is determined according to a parameter for determining a number of PSFCH resources for SL HARQ-ACK reporting.

In some embodiments of the method 800, time gaps between the combined PSCCH/PSSCH and the one or more large-payload format PSFCHs are determined using a first time gap configuration parameter that is longer than a second time gap configuration parameter that is for use between the combined PSCCH/PSSCH and the format 0 PSFCH.

In some embodiments, the method 800 further includes identifying that the UE has SL HARQ-ACK data to transmit, and the one or more large-payload format PSFCHs further comprise the HARQ-ACK data.

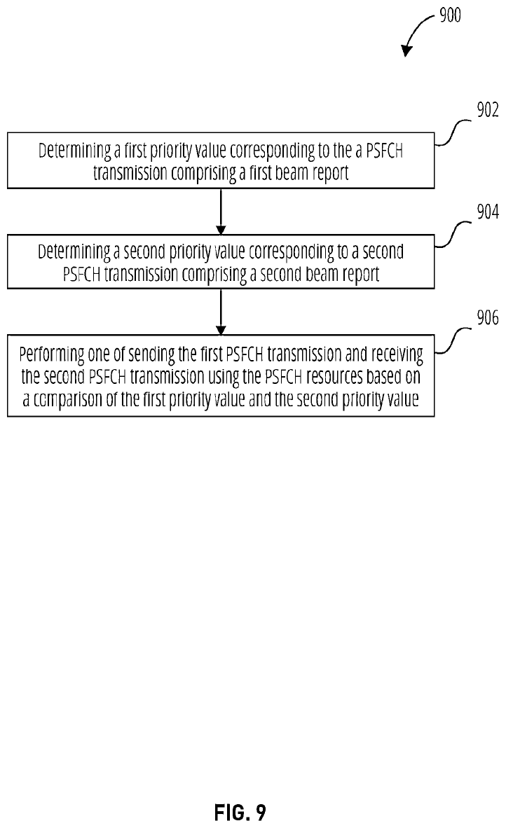

FIG. 9 illustrates a method 900 of a UE for determining a priority between using PSFCH resources to send a first PSFCH transmission comprising a first beam report and using the PSFCH resources to receive a second PSFCH transmission comprising a second beam report, according to an embodiment. The method 900 includes determining 902 a first priority value corresponding to the first PSFCH transmission comprising the first beam report.

The method 900 further includes determining 904 a second priority value corresponding to the second PSFCH transmission comprising the second beam report.

The method 900 further includes performing 906 one of sending the first PSFCH transmission and receiving the second PSFCH transmission using the PSFCH resources based on a comparison of the first priority value and the second priority value.

In some embodiments of the method 900, the first priority value is received from a sidelink (SL) UE in SCI configured to trigger the sending of the first PSFCH transmission.

In some embodiments of the method 900, the first PSFCH transmission comprises a large-payload format PSFCH, wherein the large-payload format PSFCH is longer than a format 0 PSFCH, and the first priority value is determined according to a resource pool used for the first PSFCH transmission.

In some embodiments of the method 900, the first PSFCH transmission comprises a first format 0 PSFCH, and the second PSFCH transmission comprises a second format 0 PSFCH.

In some embodiments of the method 900, the first PSFCH transmission comprises a first large-payload format PSFCH, and the second PSFCH transmission comprises a second large-payload format PSFCH, wherein the first large-payload format PSFCH and the second large-payload format PSFCH are longer than a format 0 PSFCH.

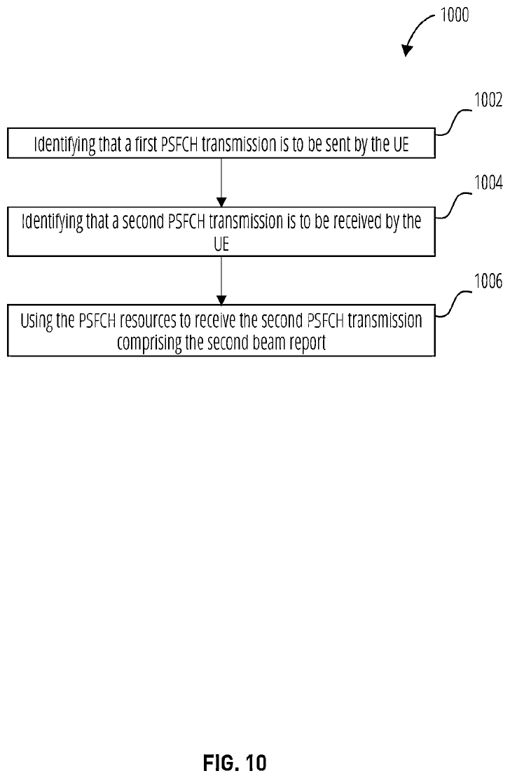

FIG. 10 illustrates a method 1000 of a UE for determining a priority between using PSFCH resources to send a first PSFCH transmission comprising a first beam report and using the PSFCH resources to receive a second PSFCH transmission comprising a second beam report, according to an embodiment. The method 1000 includes identifying 1002 that the first PSFCH transmission is to be sent by the UE.

The method 1000 further includes identifying 1004 that the second PSFCH transmission is to be received by the UE.

The method 1000 further includes using 1006 the PSFCH resources to receive the second PSFCH transmission comprising the second beam report.

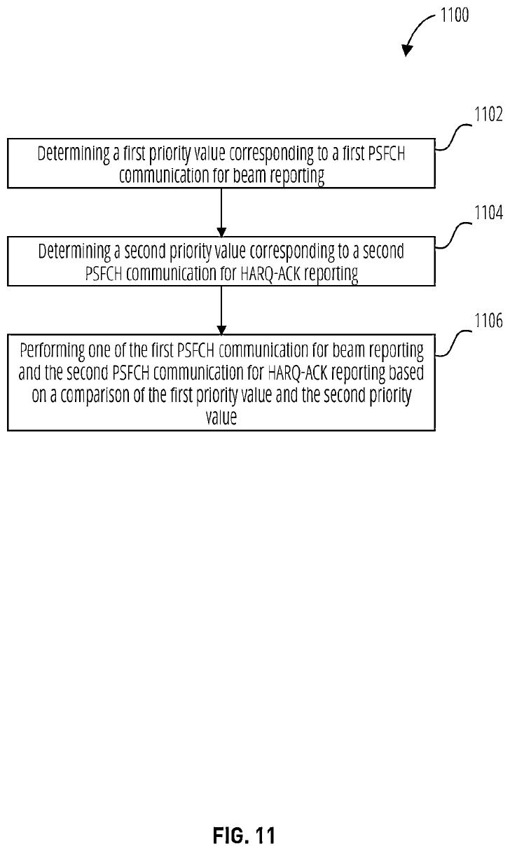

FIG. 11 illustrates a method 1100 of a UE for determining a priority between a first PSFCH communication for beam reporting and a second PSFCH communication for SL HARQ-ACK reporting, according to an embodiment. The method 1100 includes determining 1102 a first priority value corresponding to the first PSFCH communication for beam reporting.

The method 1100 further includes determining 1104 a second priority value corresponding to the second PSFCH communication for HARQ-ACK reporting.

The method 1100 further includes performing 1106 one of the first PSFCH communication for beam reporting and the second PSFCH communication for HARQ-ACK reporting based on a comparison of the first priority value and the second priority value.

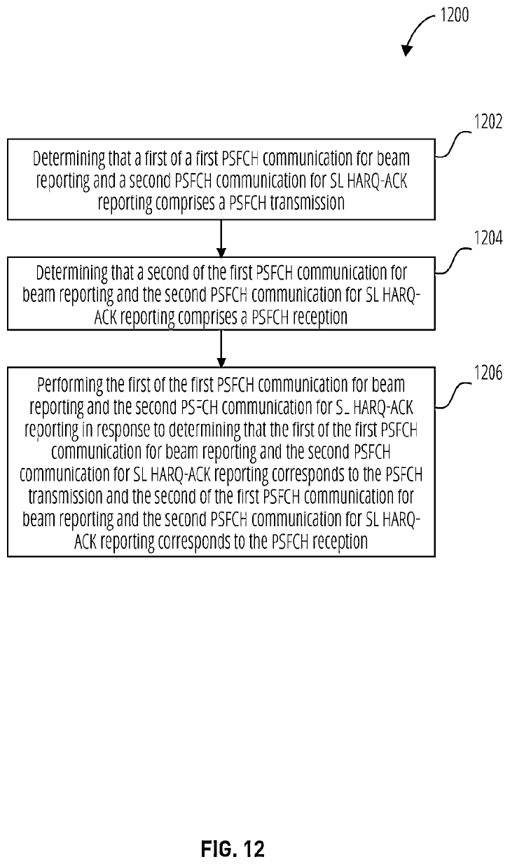

FIG. 12 illustrates a method 1200 of a UE for determining a priority between a first PSFCH communication for beam reporting and a second PSFCH communication for SL HARQ-ACK reporting, according to an embodiment. The method 1200 includes determining 1202 that a first of the first PSFCH communication for beam reporting and the second PSFCH communication for SL HARQ-ACK reporting comprises a PSFCH transmission.

The method 1200 further includes determining 1204 that a second of the first PSFCH communication for beam reporting and the second PSFCH communication for SL HARQ-ACK reporting comprises a PSFCH reception.

The method 1200 further includes performing 1206 the first of the first PSFCH communication for beam reporting and the second PSFCH communication for SL HARQ-ACK reporting in response to determining that the first of the first PSFCH communication for beam reporting and the second PSFCH communication for SL HARQ-ACK reporting corresponds to the PSFCH transmission and the second of the first PSFCH communication for beam reporting and the second PSFCH communication for SL HARQ-ACK reporting corresponds to the PSFCH reception.

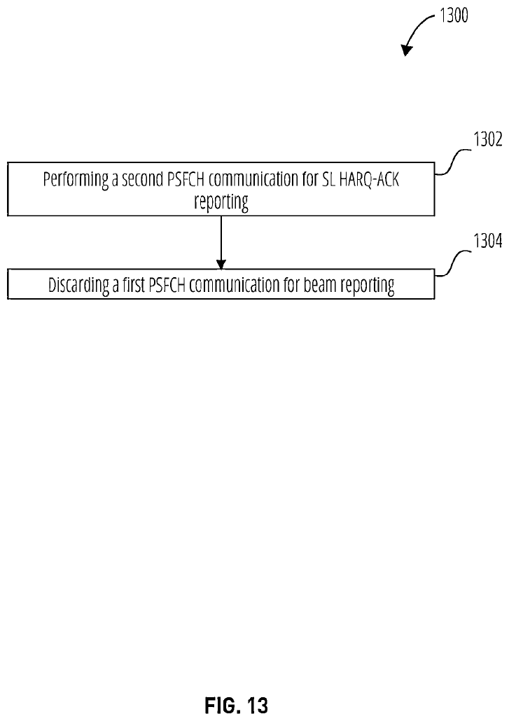

FIG. 13 illustrates a method 1300 of a UE for determining a priority between a first PSFCH communication for beam reporting and a second PSFCH communication for SL HARQ-ACK reporting, according to an embodiment. The method 1300 includes performing 1302 the second PSFCH communication for SL HARQ-ACK reporting.

The method 1300 further includes discarding 1304 the first PSFCH communication for beam reporting.

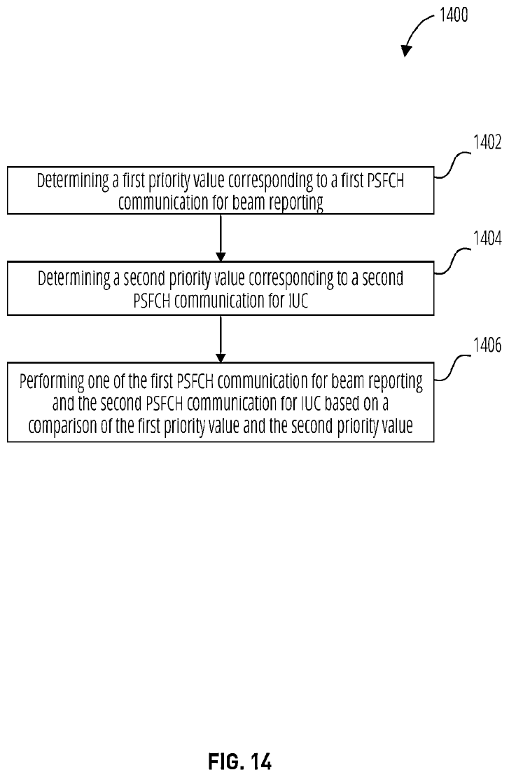

FIG. 14 illustrates a method 1400 of a user UE for determining a priority between a first PSFCH communication for beam reporting and a second PSFCH communication for IUC, according to an embodiment. The method 1400 includes determining 1402 a first priority value corresponding to the first PSFCH communication for beam reporting.

The method 1400 further includes determining 1404 a first priority value corresponding to the first PSFCH communication for beam reporting.

The method 1400 further includes performing 1406 one of the first PSFCH communication for beam reporting and the second PSFCH communication for IUC based on a comparison of the first priority value and the second priority value.

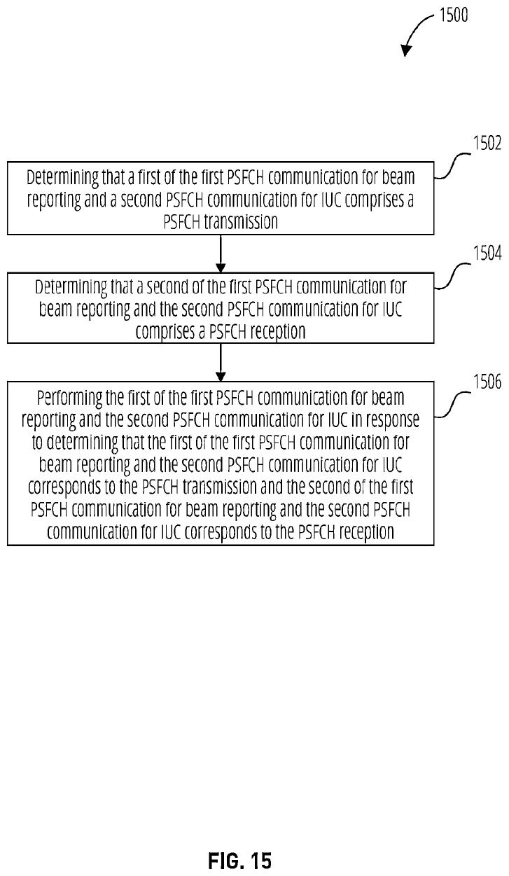

FIG. 15 illustrates a method 1500 of a UE for determining a priority between a first PSFCH communication for beam reporting and a second PSFCH communication for IUC, according to an embodiment. The method 1500 includes determining 1502 that a first of the first PSFCH communication for beam reporting and the second PSFCH communication for IUC comprises a PSFCH transmission.

The method 1500 further includes determining 1504 that a second of the first PSFCH communication for beam reporting and the second PSFCH communication for IUC comprises a PSFCH reception.

The method 1500 further includes performing 1506 the first of the first PSFCH communication for beam reporting and the second PSFCH communication for IUC in response to determining that the first of the first PSFCH communication for beam reporting and the second PSFCH communication for IUC corresponds to the PSFCH transmission and the second of the first PSFCH communication for beam reporting and the second PSFCH communication for IUC corresponds to the PSFCH reception.

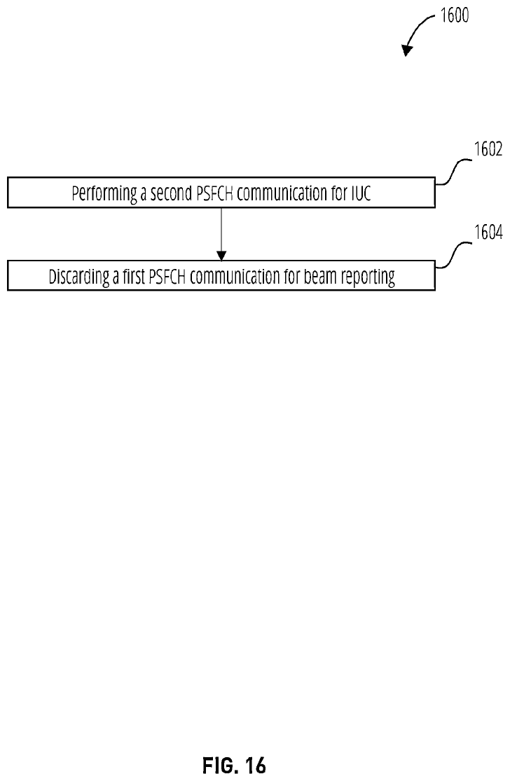

FIG. 16 illustrates a method 1600 for determining a priority between a first PSFCH communication for beam reporting and a second PSFCH communication for IUC, according to an embodiment. The method 1600 includes performing 1602 the second PSFCH communication for IUC.

The method 1600 further includes discarding 1604 the first PSFCH communication for beam reporting

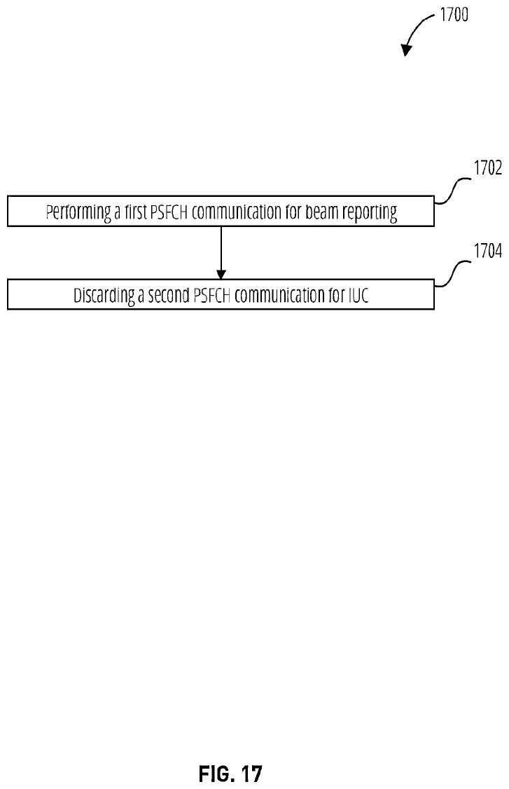

FIG. 17 illustrates a method 1700 for determining a priority between a first PSFCH communication for beam reporting and a second PSFCH communication for IUC, according to an embodiment. The method 1700 includes performing 1702 the first PSFCH communication for beam reporting.

The method 1700 further includes discarding 1704 the second PSFCH communication for IUC.

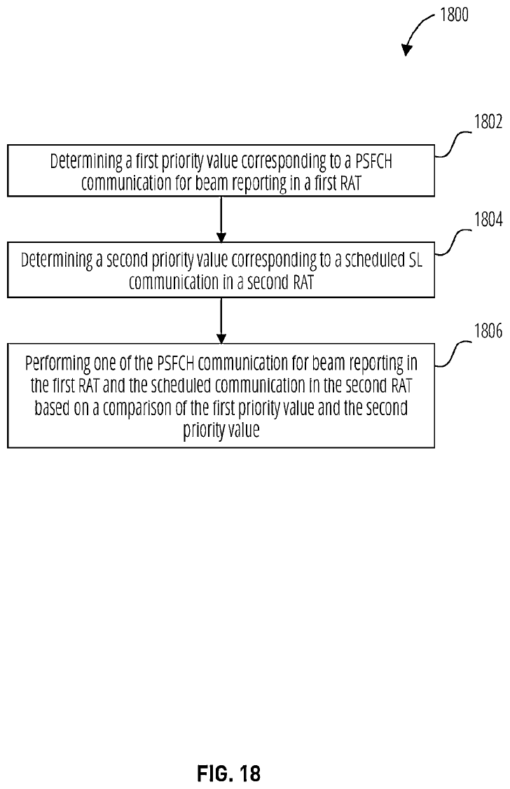

FIG. 18 illustrates a method 1800 of a UE for determining a priority between a PSFCH communication for beam reporting in a first RAT and performing a scheduled SL communication in a second RAT, according to an embodiment. The method 1800 includes determining 1802 a first priority value corresponding to the PSFCH communication for beam reporting in the first RAT.

The method 1800 further includes determining 1804 a second priority value corresponding to the scheduled SL communication in the second RAT.

The method 1800 further includes performing 1806 one of the PSFCH communication for beam reporting in the first RAT and the scheduled communication in the second RAT based on a comparison of the first priority value and the second priority value.

In some embodiments of the method 1800, the PSFCH communication for beam reporting in the first RAT comprises a format 0 PSFCH.

In some embodiments of the method 1800, the PSFCH communication for beam reporting in the first RAT comprises a large-payload format PSFCH, wherein the large-payload format PSFCH is longer than a format 0 PSFCH.

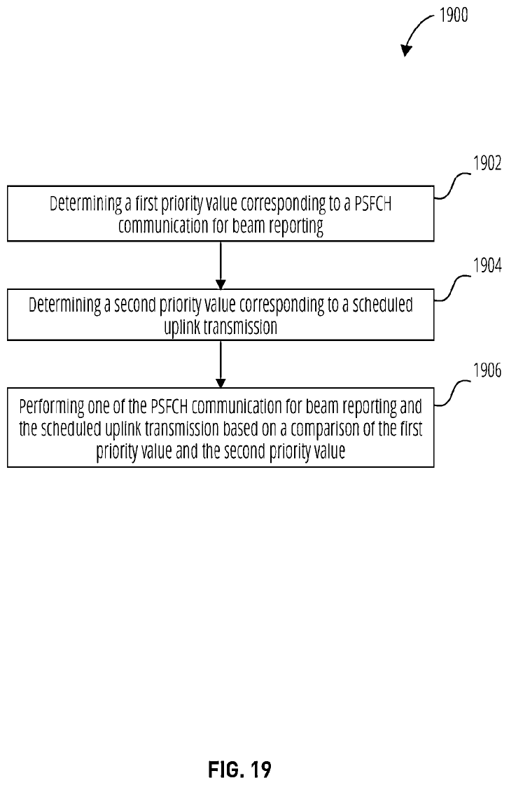

FIG. 19 illustrates a method 1900 of a UE for determining a priority between a PSFCH communication for beam reporting and performing a scheduled uplink transmission, according to an embodiment. The method 1900 includes determining 1902 a first priority value corresponding to the PSFCH communication for beam reporting.

The method 1900 further includes determining 1904 a second priority value corresponding to the scheduled uplink transmission.

The method 1900 further includes performing 1906 one of the PSFCH communication for beam reporting and the scheduled uplink transmission based on a comparison of the first priority value and the second priority value.

In some embodiments of the method 1900, the PSFCH communication for beam reporting comprises a format 0 PSFCH.

In some embodiments of the method 1900, the PSFCH communication for beam reporting comprises a large-payload format PSFCH, wherein the large-payload format PSFCH is longer than a format 0 PSFCH.

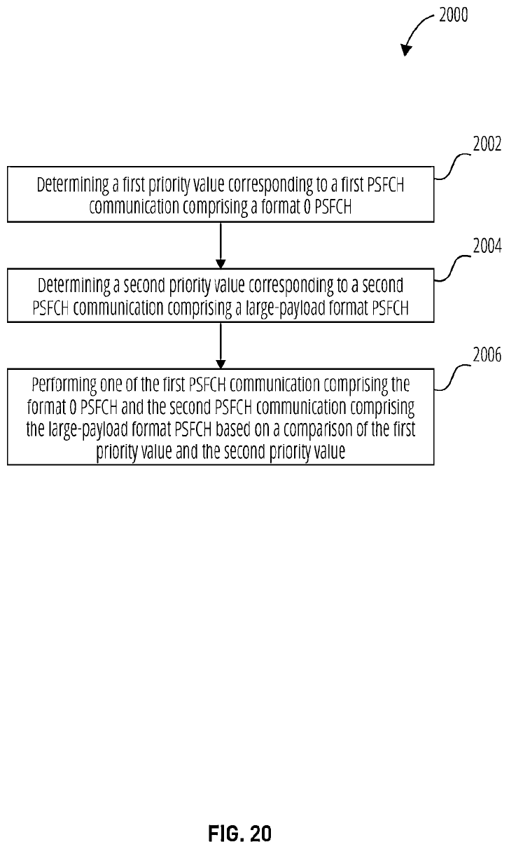

FIG. 20 illustrates a method 2000 of a UE for determining a priority between a first PSFCH communication comprising a format 0 PSFCH and a second PSFCH communication comprising a large-payload format PSFCH that is longer than a format 0 PSFCH, according to an embodiment. The method 2000 includes determining 2002 a first priority value corresponding to the first PSFCH communication comprising the format 0 PSFCH.

The method 2000 further includes determining 2004 a second priority value corresponding to the second PSFCH communication comprising the large-payload format PSFCH.

The method 2000 further includes performing 2006 one of the first PSFCH communication comprising the format 0 PSFCH and the second PSFCH communication comprising the large-payload format PSFCH based on a comparison of the first priority value and the second priority value.

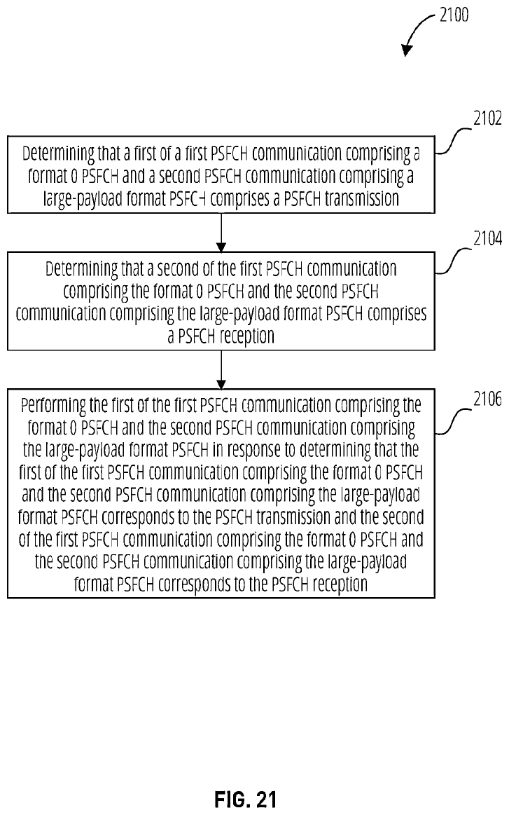

FIG. 21 illustrates a method 2100 of a UE for determining a priority between a first PSFCH communication comprising a format 0 PSFCH and a second PSFCH communication comprising a large-payload format PSFCH that is longer than a format 0 PSFCH, according to an embodiment. The method 2100 includes determining 2102 that a first of the first PSFCH communication comprising the format 0 PSFCH and the second PSFCH communication comprising the large-payload format PSFCH comprises a PSFCH transmission.

The method 2100 further includes determining 2104 that a second of the first PSFCH communication comprising the format 0 PSFCH and the second PSFCH communication comprising the large-payload format PSFCH comprises a PSFCH reception.

The method 2100 further includes performing 2106 the first of the first PSFCH communication comprising the format 0 PSFCH and the second PSFCH communication comprising the large-payload format PSFCH in response to determining that the first of the first PSFCH communication comprising the format 0 PSFCH and the second PSFCH communication comprising the large-payload format PSFCH corresponds to the PSFCH transmission and the second of the first PSFCH communication comprising the format 0PSFCH and the second PSFCH communication comprising the large-payload format PSFCH corresponds to the PSFCH reception.

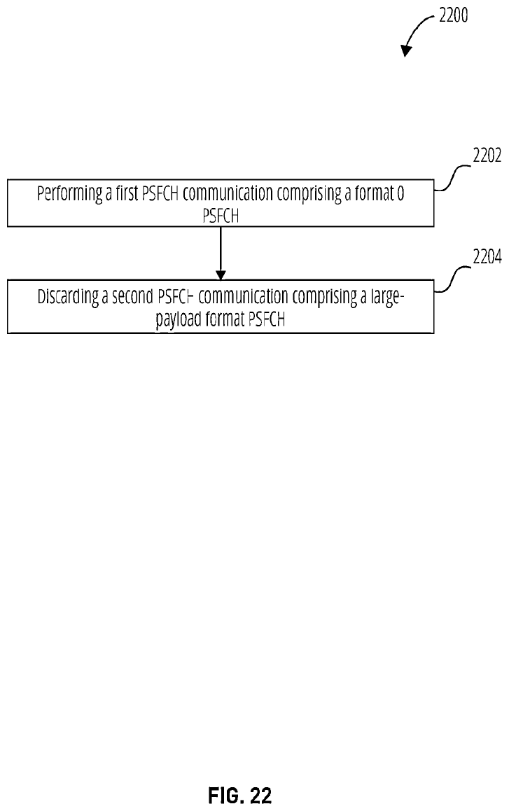

FIG. 22 illustrates a method 2200 of a UE for determining a priority between a first PSFCH communication comprising a format 0 PSFCH and a second PSFCH communication comprising a large-payload format PSFCH that is longer than a format 0 PSFCH, according to an embodiment. The method 2200 includes performing 2202 the first PSFCH communication comprising the format 0 PSFCH.

The method 2200 further includes discarding 2204 the second PSFCH communication comprising the large-payload format PSFCH.

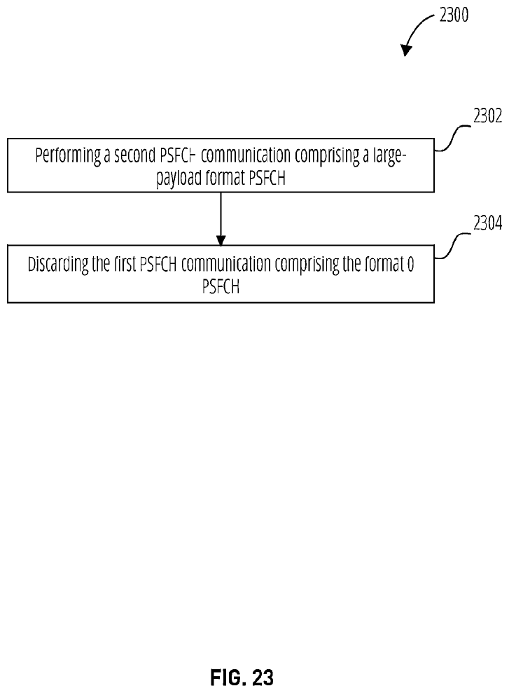

FIG. 23 illustrates a method 2300 of a UE for determining a priority between a first PSFCH communication comprising a format 0 PSFCH and a second PSFCH communication comprising a large-payload format PSFCH that is longer than a format 0 PSFCH, according to an embodiment. The method 2300 includes performing 2302 the second PSFCH communication comprising the large-payload format PSFCH.

The method 2300 further includes discarding 2304 the first PSFCH communication comprising the format 0 PSFCH

Embodiments contemplated herein include an apparatus comprising means to perform one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300. This apparatus may be, for example, an apparatus of a UE (such as one of the first wireless device 2502 or the second wireless device 2518 that is a UE, as described herein).

Embodiments contemplated herein include one or more non-transitory computer-readable media comprising instructions to cause an electronic device, upon execution of the instructions by one or more processors of the electronic device, to perform one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300. This non-transitory computer-readable media may be, for example, a memory of a UE (such as a memory 2506 or memory 2522 of one of the first wireless device 2502 or the second wireless device 2518 that is a UE, as described herein).

Embodiments contemplated herein include an apparatus comprising logic, modules, or circuitry to perform one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300. This apparatus may be, for example, an apparatus of a UE (such as one of the first wireless device 2502 or the second wireless device 2518 that is a UE, as described herein).

Embodiments contemplated herein include an apparatus comprising: one or more processors and one or more computer-readable media comprising instructions that, when executed by the one or more processors, cause the one or more processors to perform one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300. This apparatus may be, for example, an apparatus of a UE (such as one of the first wireless device 2502 or the second wireless device 2518 that is a UE, as described herein).

Embodiments contemplated herein include a signal as described in or related to one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300.

Embodiments contemplated herein include a computer program or computer program product comprising instructions, wherein execution of the program by a processor is to cause the processor to carry out one or more elements of the method 500, the method 600, the method 700, the method 800, the method 900, the method 1000, the method 1100, the method 1200, the method 1300, the method 1400, the method 1500, the method 1600, the method 1700, the method 1800, the method 1900, the method 2000, the method 2100, the method 2200, and/or the method 2300. The processor may be a processor of a UE (such as processor(s) 2504 or processor(s) 2520 of one of the first wireless device 2502 or the second wireless device 2518 that is a UE, as described herein). These instructions may be, for example, located in the processor and/or on a memory of the UE (such as a memory 2506 or memory 2522 of one of the first wireless device 2502 or the second wireless device 2518 that is a UE, as described herein).

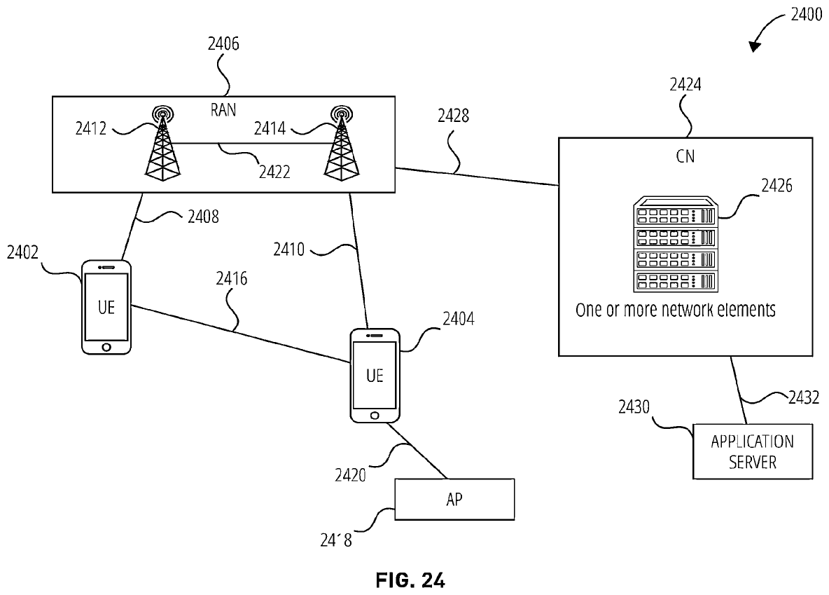

FIG. 24 illustrates an example architecture of a wireless communication system 2400, according to embodiments disclosed herein. The following description is provided for an example wireless communication system 2400 that operates in conjunction with the LTE system standards and/or 5G or NR system standards as provided by 3GPP technical specifications.

As shown by FIG. 24, the wireless communication system 2400 includes UE 2402 and UE 2404 (although any number of UEs may be used). In this example, the UE 2402 and the UE 2404 are illustrated as smartphones (e.g., handheld touchscreen mobile computing devices connectable to one or more cellular networks), but may also comprise any mobile or non-mobile computing device configured for wireless communication.

The UE 2402 and UE 2404 may be configured to communicatively couple with a RAN 2406. In embodiments, the RAN 2406 may be NG-RAN, E-UTRAN, etc. The UE 2402 and UE 2404 utilize connections (or channels) (shown as connection 2408 and connection 2410, respectively) with the RAN 2406, each of which comprises a physical communications interface. The RAN 2406 can include one or more base stations, such as base station 2412 and base station 2414, which enable the connection 2408 and the connection 2410.

In this example, the connection 2408 and connection 2410 are air interfaces to enable such communicative coupling, and may be consistent with RAT(s) used by the RAN 2406, such as, for example, an LTE and/or NR.

In some embodiments, the UE 2402 and UE 2404 may also directly exchange communication data via a sidelink interface 2416. The UE 2404 is shown to be configured to access an access point (shown as AP 2418) via connection 2420. By way of example, the connection 2420 can comprise a local wireless connection, such as a connection consistent with any IEEE 802.11 protocol, wherein the AP 2418 may comprise a Wi-Fi® router. In this example, the AP 2418 may be connected to another network (for example, the Internet) without going through a CN 2424.

In embodiments, the UE 2402 and UE 2404 can be configured to communicate using orthogonal frequency division multiplexing (OFDM) communication signals with each other or with the base station 2412 and/or the base station 2414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2412 or base station 2414 may be implemented as one or more software entities running on server computers as part of a virtual network. In addition, or in other embodiments, the base station 2412 or base station 2414 may be configured to communicate with one another via interface 2422. In embodiments where the wireless communication system 2400 is an LTE system (e.g., when the CN 2424 is an EPC), the interface 2422 may be an X2 interface. The X2 interface may be defined between two or more base stations (e.g., two or more eNBs and the like) that connect to an EPC, and/or between two eNBs connecting to the EPC. In embodiments where the wireless communication system 2400 is an NR system (e.g., when CN 2424 is a 5GC), the interface 2422 may be an Xn interface. The Xn interface is defined between two or more base stations (e.g., two or more gNBs and the like) that connect to 5GC, between a base station 2412 (e.g., a gNB) connecting to 5GC and an eNB, and/or between two eNBs connecting to 5GC (e.g., CN 2424).

The RAN 2406 is shown to be communicatively coupled to the CN 2424. The CN 2424 may comprise one or more network elements 2426, which are configured to offer various data and telecommunications services to customers/subscribers (e.g., users of UE 2402 and UE 2404) who are connected to the CN 2424 via the RAN 2406. The components of the CN 2424 may be implemented in one physical device or separate physical devices including components to read and execute instructions from a machine-readable or computer-readable medium (e.g., a non-transitory machine-readable storage medium)

In embodiments, the CN 2424 may be an EPC, and the RAN 2406 may be connected with the CN 2424 via an S1 interface 2428. In embodiments, the SI interface 2428 may be split into two parts, an S1 user plane (S1-U) interface, which carries traffic data between the base station 2412 or base station 2414 and a serving gateway (S-GW), and the S1-MME interface, which is a signaling interface between the base station 2412 or base station 2414 and mobility management entities (MMEs).

In embodiments, the CN 2424 may be a 5GC, and the RAN 2406 may be connected with the CN 2424 via an NG interface 2428. In embodiments, the NG interface 2428 may be split into two parts, an NG user plane (NG-U) interface, which carries traffic data between the base station 2412 or base station 2414 and a user plane function (UPF), and the S1 control plane (NG-C) interface, which is a signaling interface between the base station 2412 or base station 2414 and access and mobility management functions (AMFs).

Generally, an application server 2430 may be an element offering applications that use internet protocol (IP) bearer resources with the CN 2424 (e.g., packet switched data services). The application server 2430 can also be configured to support one or more communication services (e.g., VoIP sessions, group communication sessions, etc.) for the UE 2402 and UE 2404 via the CN 2424. The application server 2430 may communicate with the CN 2424 through an IP communications interface 2432.

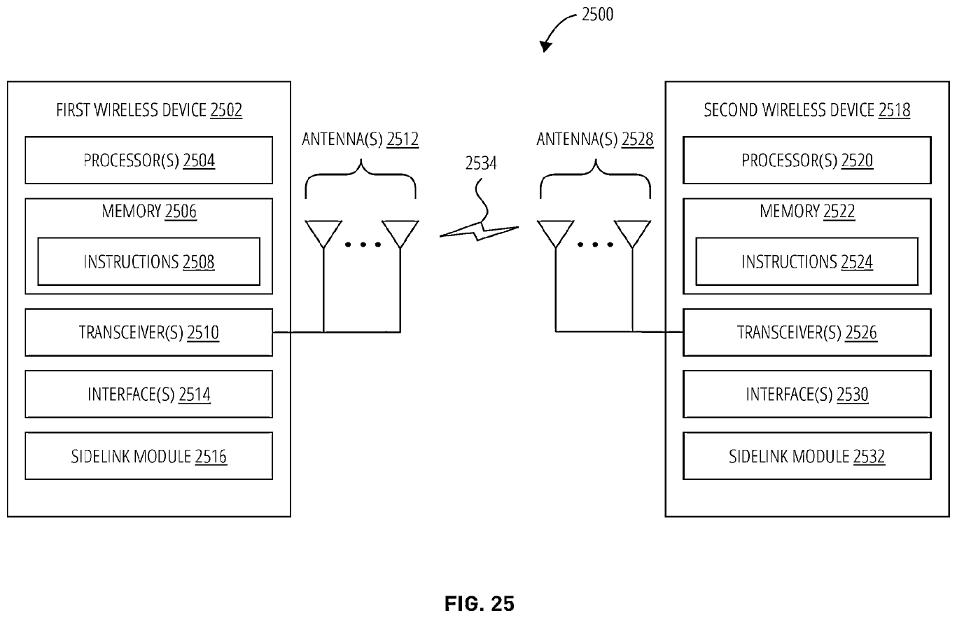

FIG. 25 illustrates a system 2500 for performing signaling 2534 between a first wireless device 2502 and a second wireless device 2518, according to embodiments disclosed herein. The system 2500 may be a portion of a wireless communications system as herein described. The first wireless device 2502 may be, for example, a UE of a wireless communication system. The second wireless device 2518 may be, for example, a UE of the wireless communication system.

The first wireless device 2502 may include one or more processor(s) 2504. The processor(s) 2504 may execute instructions such that various operations of the first wireless device 2502 are performed, as described herein. The processor(s) 2504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The first wireless device 2502 may include a memory 2506. The memory 2506 may be a non-transitory computer-readable storage medium that stores instructions 2508 (which may include, for example, the instructions being executed by the processor(s) 2504). The instructions 2508 may also be referred to as program code or a computer program. The memory 2506 may also store data used by, and results computed by, the processor(s) 2504.

The first wireless device 2502 may include one or more transceiver(s) 2510 that may include radio frequency (RF) transmitter and/or receiver circuitry that use the antenna(s) 2512 of the first wireless device 2502 to facilitate signaling (e.g., the signaling 2534) to and/or from the first wireless device 2502 with other devices (e.g., the second wireless device 2518) according to corresponding RATs.

The first wireless device 2502 may include one or more antenna(s) 2512 (e.g., one, two, four, or more). For embodiments with multiple antenna(s) 2512, the first wireless device 2502 may leverage the spatial diversity of such multiple antenna(s) 2512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the first wireless device 2502 may be accomplished according to precoding (or digital beamforming) that is applied at the first wireless device 2502 that multiplexes the data streams across the antenna(s) 2512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the first wireless device 2502 may implement analog beamforming techniques, whereby phases of the signals sent by the antenna(s) 2512 are relatively adjusted such that the (joint) transmission of the antenna(s) 2512 can be directed (this is sometimes referred to as beam steering).

The first wireless device 2502 may include one or more interface(s) 2514. The interface(s) 2514 may be used to provide input to or output from the first wireless device 2502. For example, a first wireless device 2502 that is a UE may include interface(s) 2514 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 2510/antenna(s) 2512 already described) that allow for communication between the UE and other devices and may operate according to known protocols (e.g., Wi-Fi®, Bluetooth®, and the like).

The first wireless device 2502 may include a sidelink module 2516. The sidelink module 2516 may be implemented via hardware, software, or combinations thereof. For example, the sidelink module 2516 may be implemented as a processor, circuit, and/or instructions 2508 stored in the memory 2506 and executed by the processor(s) 2504. In some examples, the sidelink module 2516 may be integrated within the processor(s) 2504 and/or the transceiver(s) 2510. For example, the sidelink module 2516 may be implemented by a combination of software components (e.g., executed by a DSP or a general processor) and hardware components (e.g., logic gates and circuitry) within the processor(s) 2504 or the transceiver(s) 2510.

The sidelink module 2516 may be used for various aspects of the present disclosure, for example, aspects of FIG. 1 to FIG. 23. For example, the sidelink module 2516 may be configured to perform procedures for transmitting SL beam reporting via PSSCH as described herein, to perform procedures for transmitting SL beam reporting via PSFCH format 0 as described herein, and/or to perform procedures for transmitting SL beam reporting via a large-format PSFCH as described herein. The sidelink module 2516 may be configured to enact functionalities of one of a Tx UE 102 and/or an Rx UE 104, as described herein.

The second wireless device 2518 may include one or more processor(s) 2520. The processor(s) 2520 may execute instructions such that various operations of the second wireless device 2518 are performed, as described herein. The processor(s) 2520 may include one or more baseband processors implemented using, for example, a CPU, a DSP, an ASIC, a controller, an FPGA device, another hardware device, a firmware device, or any combination thereof configured to perform the operations described herein.

The second wireless device 2518 may include a memory 2522. The memory 2522 may be a non-transitory computer-readable storage medium that stores instructions 2524 (which may include, for example, the instructions being executed by the processor(s) 2520). The instructions 2524 may also be referred to as program code or a computer program. The memory 2522 may also store data used by, and results computed by, the processor(s) 2520.

The second wireless device 2518 may include one or more transceiver(s) 2526 that may include RF transmitter and/or receiver circuitry that use the antenna(s) 2528 of the second wireless device 2518 to facilitate signaling (e.g., the signaling 2534) to and/or from the second wireless device 2518 with other devices (e.g., the first wireless device 2502) according to corresponding RATs.

The second wireless device 2518 may include one or more antenna(s) 2528 (e.g., one, two, four, or more). In embodiments having multiple antenna(s) 2528, the second wireless device 2518 may perform MIMO, digital beamforming, analog beamforming, beam steering, etc., as has been described.

The second wireless device 2518 may include one or more interface(s) 2530. The interface(s) 2530 may be used to provide input to or output from the second wireless device 2518. For example, a second wireless device 2518 that is a UE may include interface(s) 2530 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 2526/antenna(s) 2528 already described) that allow for communication between the UE and other devices and may operate according to known protocols (e.g., Wi-Fi®, Bluetooth®, and the like).

The second wireless device 2518 may include a sidelink module 2532. The sidelink module 2532 may be implemented via hardware, software, or combinations thereof. For example, the sidelink module 2532 may be implemented as a processor, circuit, and/or instructions 2524 stored in the memory 2522 and executed by the processor(s) 2520. In some examples, the sidelink module 2532 may be integrated within the processor(s) 2520 and/or the transceiver(s) 2526. For example, the sidelink module 2532 may be implemented by a combination of software components (e.g., executed by a DSP or a general processor) and hardware components (e.g., logic gates and circuitry) within the processor(s) 2520 or the transceiver(s) 2526.

The sidelink module 2532 may be used for various aspects of the present disclosure, for example, aspects of FIG. 1 through FIG. 23. For example, the sidelink module 2532 may be configured to perform procedures for transmitting SL beam reporting via PSSCH as described herein, to perform procedures for transmitting SL beam reporting via PSFCH format 0 as described herein, and/or to perform procedures for transmitting SL beam reporting via a large-format PSFCH as described herein. The sidelink module 2532 may be configured to enact functionalities of one of a Tx UE 102 and/or an Rx UE 104 (e.g., opposite of the functionality currently enacted by the sidelink module 2516), as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a receive (Rx) user equipment (UE) for performing sidelink (SL) communications with a transmit (Tx) UE, comprising:
receiving, from the Tx UE, sidelink control information (SCI) configured to trigger a beam report by the Rx UE;
performing a beam measurement corresponding to the beam report using one or more channel state information reference signals (CSI-RSs) sent to the Rx UE by the Tx UE; and
sending a combined physical sidelink control channel (PSCCH)/physical sidelink shared channel (PSSCH) transmission to the Tx UE, the combined PSCCH/PSSCH transmission comprising a medium access control control element (MAC CE) comprising the beam report.

2. The method of claim 1, wherein resources for the combined PSCCH/PSSCH transmission are selected according to a SL resource selection procedure.

3. The method of claim 2, wherein a priority value for the combined PSCCH/PSSCH transmission used during the SL resource selection procedure is received in the SCI.

4. The method of claim 2, wherein a priority value for the combined PSCCH/PSSCH transmission used during the SL resource selection procedure is determined at the Rx UE according to the MAC CE.

5. The method of claim 2, wherein:
the MAC CE comprising the beam report is multiplexed with other data in the combined PSCCH/PSSCH transmission; and
a priority value for the combined PSCCH/PSSCH transmission used during the SL resource selection procedure is the lower of a first priority value corresponding to the beam report and a second priority value corresponding to the other data.

6. The method of claim 2, wherein a packet delay budget (PDB) for the combined PSCCH/PSSCH transmission is less than or equal to a latency bound corresponding to the beam report.

7. The method of claim 1, wherein the combined PSCCH/PSSCH transmission uses dedicated resources.

8. The method of claim 7, wherein the dedicated resources are resources reserved by the SCI.

9. The method of claim 7, wherein the dedicated resources are determined at the Rx UE according to a resource pool used for the combined PSCCH/PSSCH transmission.

10. A method of a receive (Rx) user equipment (UE) for performing sidelink (SL) communications with a transmit (Tx) UE, comprising:
receiving, from the Tx UE, first sidelink control information (SCI) configured to trigger a beam report by the Rx UE;
performing a beam measurement corresponding to the beam report using one or more channel state information reference signals (CSI-RSs) sent to the Rx UE by the Tx UE; and
sending second SCI to the Tx UE, wherein stage 2 of the second SCI comprises the beam report.

11. The method of claim 10, wherein stage 1 of the second SCI comprises a number of beam identifier (ID) to measured quality value pairs used in the beam report.

12. The method of claim 10, wherein the beam report comprises a measured quality of up to a number of beams that is known to the Rx UE.

13. The method of claim 12, wherein the number of beams is pre-configured to the Rx UE according to a SL resource pool used for the second SCI.

14. The method of claim 12, wherein the number of beams is configured to the Rx UE by SL signaling between the Rx UE and the Tx UE.

15. A method of a receive (Rx) user equipment (UE) for performing sidelink (SL) communications with a transmit (Tx) UE, comprising:
receiving, from the Tx UE, a combined physical sidelink control channel (PSCCH)/physical sidelink shared channel (PSSCH) having sidelink control information (SCI) configured to trigger a beam report by the Rx UE;
performing a beam measurement corresponding to the beam report using one or more channel state information reference signals (CSI-RSs) of the combined PSCCH/PSSCH;
identifying one or more physical sidelink feedback channel (PSFCH) resources from a PSFCH SL beam reporting region; and
sending one or more format 0 PSFCHs to the Tx UE using the one or more PSFCH resources, the one or more format 0 PSFCHs comprising the beam report.

16. The method of claim 15, wherein the PSFCH SL beam reporting region is located in a time domain according to a parameter for time domain PSFCH resource location for SL hybrid automatic repeat request acknowledgement (HARQ-ACK) transmissions.

17. The method of claim 15, wherein a location of the PSFCH SL beam reporting region in a frequency domain is indicated by a bitmap indicating resource blocks (RBs) of the PSFCH SL beam reporting region.

18. The method of claim 15, wherein the PSFCH SL beam reporting region is located in a code domain according to a parameter for applying cyclic shifting to SL hybrid automatic repeat request acknowledgement (HARQ-ACK) reporting.

19. The method of claim 15, wherein a number of the one or more PSFCH resources is determined at the Rx UE according to a resource pool used for the combined PSCCH/PSSCH.

20. The method of claim 15, wherein a number of the one or more PSFCH resources is determined according to a parameter for determining a number of PSFCH resources for SL hybrid automatic repeat request acknowledgement (HARQ-ACK) reporting.

21-59. (canceled)
